(19) United States
(12) Patent Application Publication
(10) Pub. No.: US 2026/0072869 A1
(43) Pub. Date: Mar. 12, 2026

(54) TECHNIQUES FOR GENERATING AND UTILIZING CLOUD SERVICE IMAGES

(71) Applicant: Oracle International Corporation, Redwood Shores, CA (US)

(72) Inventors: Philip James Ramsey, Bainbridge Island, WA (US); Lucas Michael Kreger-Stickles, Seattle, WA (US)

(21) Appl. No.: 18/827,651

(22) Filed: Sep. 6, 2024

(51) Int. Cl. G06F 16/11; G06F 16/16; G06F 16/182

(52) U.S. Cl. CPC G06F 16/128; G06F 16/164; G06F 16/182

(57) ABSTRACT

Techniques discussed herein relate to generating and utilizing snapshots (also referred to as “service images”) of a cloud-based service. A snapshot may be generated within a source environment (e.g., one compartment and/or region) and re-instantiated in a target environment (e.g., a different compartment and/or region, the same compartment/region as would be the case in a recovery scenario). The snapshot may include serialized data of any suitable combination of resource metadata, images, block/boot volume content, runtime state data, environmental variables, and the like of the service of the source environment, at a time at which the snapshot was generated. The snapshot may be deserialized in the target environment and used to perform infrastructure and/or artifact/software releases to bring the control plane and/or data plane resources of the target environment to a desired state corresponding to the state of the service in the source environment when the snapshot was generated.

### BACKGROUND

Building and deploying cloud services from scratch involves several critical steps to ensure reliability and efficiency. Initially, this process begins with the design and architecture phase, where the specific requirements of the service are defined, including scalability, security, performance, and compliance needs. Architects must choose the appropriate cloud service model and cloud provider based on the service requirements. This phase also involves selecting the right tools and technologies for infrastructure management, such as Infrastructure as Code (IaC) tools, which allow for consistent and repeatable provisioning of cloud resources. Additionally, establishing a robust Continuous Integration/Continuous Deployment (CI/CD) pipeline is crucial to automate the deployment process, integrate testing, and ensure continuous delivery of updates and features.

Once the architecture is set, the focus shifts to implementation and deployment. Implementation and deployment include setting up the runtime environment and configuring networking, security groups, and other necessary cloud resources. Implementing monitoring and logging solutions is essential to gain insights into the system's performance and to quickly identify and resolve issues. Using containerization technologies and orchestration tools can further enhance the reliability and scalability of the service by ensuring consistent environments and automated management of application workloads. Finally, thorough testing, including unit, integration, and performance testing, ensures the service meets the defined requirements and can handle real-world usage scenarios. By following these structured steps, organizations can build and deploy cloud services from scratch reliably, ensuring they are scalable, secure, and performant. As described above, reliably building and deploying cloud services from scratch is a high-cost and complex process. Automating the process and reducing the complexity is desirable and advantageous.

### BRIEF SUMMARY

Techniques are provided for the deployment of a cloud service. Various embodiments are described herein, including methods, systems, non-transitory computer-readable storage media storing programs, code, or instructions executable by one or more processors, and the like.

One embodiment is directed to a computer-implemented method (the “method,” for brevity). The method may include obtaining metadata corresponding to a first data plane resource of a first cloud computing environment by a computing system of the first cloud-computing environment. The method may include generating, by the computing system, modified metadata comprising a data object that replaces a parameter of the metadata. In some embodiments, the parameter being replaced may be identified according to a predefined parameterization specification. The method may include obtaining, by the computing system, an image that was previously installed at the first data plane resource. The method may include generating, by the computing system, serialized snapshot data corresponding to the first data plane resource. In some embodiments, the serialized snapshot data may include a plurality of data bytes generated from a combination of the image that was previously installed at the first data plane resource and the modified metadata comprising the data object that replaces the parameter of the metadata. The method may include storing, by the computing system, the serialized snapshot data corresponding to the first data plane resource. In some embodiments, the serialized snapshot data may enable a second data plane resource to be configured within a second cloud-computing environment. based at least in part on the first data plane resource of the first cloud-computing environment.

In some embodiments, the serialized snapshot data may include at least one of the snapshot identifier, a compartment identifier corresponding to the first data plane resource, a stack identifier, an image source identifier, or a network address.

In some embodiments, the metadata corresponding to the first data plane resource may be obtained from a declarative provisioning and deployment system using an application programming interface.

In some embodiments, the predefined parameterization specification may identify one or more parameters to be replaced with a corresponding data object.

In some embodiments, the method may further include obtaining, by the computing system, current state data. In some embodiments, the current state data may indicate a current state of the first data plane resource within the first cloud-computing environment. In some embodiments, the serialized snapshot data may be generated to further include the current state data that indicates the current state of the first data plane resource within the first cloud-computing environment.

In some embodiments, the method may further include identifying, by the computing system, that the first data plane resource is associated with a storage resource type. The method, in response to identifying that the first data plane resource is associated with the storage resource type, may include obtaining replicated data that replicates corresponding data stored at the first data plane resource. In some embodiments, the serialized snapshot data may be generated to further comprise the replicated data.

In some embodiments, the method may further include transmitting, by the computing system to a second computing system, a request identifying the serialized snapshot data. In some embodiments, transmitting the request may cause the second computing system to configure the second cloud-computing environment with the first data plane resource according to the serialized snapshot data generated from the first data plane resource of the first cloud-computing environment.

In some embodiments, a computing device is disclosed. The computing device may be configured with one or more processors and one or more memories configured with executable instructions that, when executed by the one or more processors, cause the computing device to perform the method disclosed in the paragraph above.

Some embodiments disclose a non-transitory computer-readable storage medium comprising computer-executable instructions that, when executed with one or more processors of a computing device, cause the computing device to perform the methods disclosed herein.

### BRIEF DESCRIPTION OF THE DRAWINGS

FIG. 1 depicts a block diagram illustrating a cloud computing environment for implementing the present disclosure, according to at least one embodiment.

FIG. 2 illustrates an example service for which a service image may be generated or used, according to at least one embodiment.

FIG. 3 illustrates an example method for generating a serialized snapshot of a service (e.g., a service image), according to at least one embodiment.

FIG. 4 illustrates an example method for deserializing a serialized snapshot, according to at least one embodiment.

FIG. 5 illustrates a schematic diagram illustrating example computer architecture for a data preparation engine, according to at least one embodiment.

FIG. 6 illustrates a schematic diagram illustrating an example computer architecture for a modification engine, according to at least one embodiment.

FIG. 7 is a block diagram illustrating another example method for generating a serialized snapshot, in accordance with at least one embodiment.

FIG. 8 is a block diagram of an environment in which a Cloud Infrastructure Orchestration System (CIOS) may operate to dynamically bootstrap services in a region, in accordance with at least one embodiment.

FIG. 9 is a block diagram for illustrating an environment and method for building a virtual bootstrap environment (ViBE), in accordance with at least one embodiment.

FIG. 10 is a block diagram for illustrating an environment and method for bootstrapping services to a target region utilizing the ViBE, in accordance with at least one embodiment.

FIG. 11 is a block diagram illustrating one pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating an example computer system, according to at least one embodiment.

### DETAILED DESCRIPTION

In the following description, various embodiments will be described. For purposes of explanation, specific configurations, and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

### INTRODUCTION

One of the objectives in modern cloud infrastructure management is to enable the efficient deployment of services in new environments. This involves setting up the necessary resources and ensuring that the configurations and states are consistent and accurate. Deploying services across different cloud environments may involve several criteria and functionalities, such as maintaining consistency, managing interdependencies, and adapting configurations to new contexts. These considerations are particularly pronounced when dealing with complex services that have numerous interconnected components.

Maintaining consistency and integrity across different environments is essential and desirable when deploying services in new infrastructure. The dynamic nature of cloud environments, where configurations and states frequently change, necessitates accurate management and adaptation of these elements to new contexts. For instance, IP addresses and MAC addresses used in one region may need to be replaced with different values in another region, adding complexity to the deployment process. Ensuring that cloud resources such as compute instances, network configurations, and databases, which often have interdependencies, are effectively managed and deployed provides consistency in the quality of service and experience to the users.

The process of setting up and deploying services in a cloud infrastructure may begin with a series of foundational steps. The first task a customer may undertake is creating a Virtual Cloud Network (VCN). This VCN may serve as the primary networking framework within which all resources are deployed. Following the creation of the VCN, the customer may launch an instance within this network. This instance may represent the compute resource that will run the necessary applications and services.

After launching the instance, the customer may configure the networking and security settings to enable communication with the instance. This involves creating a route table, setting up a security list, and establishing an Internet or NAT gateway. These components may ensure the instance can communicate with external networks and other resources within the VCN. For example, a route table directs traffic appropriately, while a security list defines the allowed traffic types and sources.

The cloud infrastructure may employ provisioning sets and service images to simplify and streamline this setup process. The concept of a service image is introduced and used to reduce the complexity of service deployment while maintaining consistency and integrity across different environments. A service image may provide a structured or parameterized representation of cloud resources, encapsulating their configuration and runtime state. A service image may include control-plane resources, runtime state, durable state in any associated assets along with any suitable metadata for those assets that allows the service, its assets, and metadata to be re-instantiated in a new environment at the same state at which a snapshot of the service used to generate the service image was taken. This comprehensive snapshot of the service can be easily stored, transported, and/or deployed across different cloud environments (e.g., compartments, regions, etc.) or within the same cloud environment for recovery purposes. By capturing all relevant data and configurations, the service image ensures that the deployed service maintains its intended behavior and performance.

The process involves serialization to create the service image and deserialization to deploy the services in a new environment or to recover or revert to a previous state within the same cloud environment. Serialization converts the configuration and state into a series of bytes, making it easier to manage and transport. During serialization, data is collected from various cloud resources, parameterized to allow for adaptability, and compiled into a single cohesive service image object. This object is then serialized and stored in a snapshot data store, ready for deployment.

A deserialization process may be used to reconstruct the service in the new environment (or in the same environment when used for recovery purposes) based on the serialized data, providing consistency and reducing deployment time. The deserialization process may read the serialized data, reconstruct the service image object, apply any necessary modifications, and instantiate and configure the service within the new environment to conform to the original service setup. This approach simplifies the deployment process and enhances the reliability and efficiency of managing cloud services and maintaining dependencies and configurations.

Service images may enhance the efficiency and reliability of deploying cloud services. One advantage of service images may be their increased determinism and predictability. Service images may reduce the risk of variations and discrepancies by ensuring that the base image and its configurations are consistent across deployments. This may be achieved by moving at least a portion of the application runtime context into the provisioning process, thereby minimizing the number of deployment steps. For example, instead of installing Java runtime and other necessary software during each deployment, these elements may be included in the service image, providing uniformity across all instances instantiated from that image.

In addition to reducing deployment steps, service images may also help maintain consistency across deployments. This is particularly important in dynamic cloud environments where configurations and states frequently change. By using a service image, organizations may increase the likelihood that all instances launched using a service image have the same base image and configurations and reduce the chances of configuration drift. For instance, if the service image is updated monthly with the latest security patches, all deployed instances will uniformly reflect these updates, thereby maintaining a consistent security posture.

Moreover, service images may simplify the deployment process by encapsulating the configuration and runtime state. They serve as bootable artifacts containing all necessary configuration(s) and software, making the deployment process more straightforward and efficient. By converting the configuration and state into a standardized format (e.g., JSON), service images make it easier to manage and transport service data. For example, an image might include all of the necessary software and configuration(s) for a web server, allowing it to be quickly deployed across environments without additional setup.

Furthermore, using service images may allow for rapid and consistent deployment of services. The serialization process may convert the configuration and state into a structured format, and deserialization may reconstruct the service in the same or a new environment based on the serialized data. This may allow the service to maintain its intended behavior and performance, reducing deployment time and enhancing reliability. For instance, a cloud provider and/or a user can use serialized images to quickly replicate its services in a new data center, ensuring minimal downtime and consistent performance.

Finally, service images may be advantageous for disaster recovery and region-build tasks. They facilitate quick and reliable deployment in different environments by providing a comprehensive snapshot of the service, including configuration and runtime state. This capability is particularly useful in disaster recovery scenarios, where services are expected to be rapidly redeployed to maintain business continuity. For example, in a data center failure, a cloud provider and/or another entity (e.g., a customer) can use service images to quickly stand up a service in a different environment (e.g., a failover environment), ensuring uninterrupted service delivery.

Embodiments described herein address these and other problems, individually and collectively.

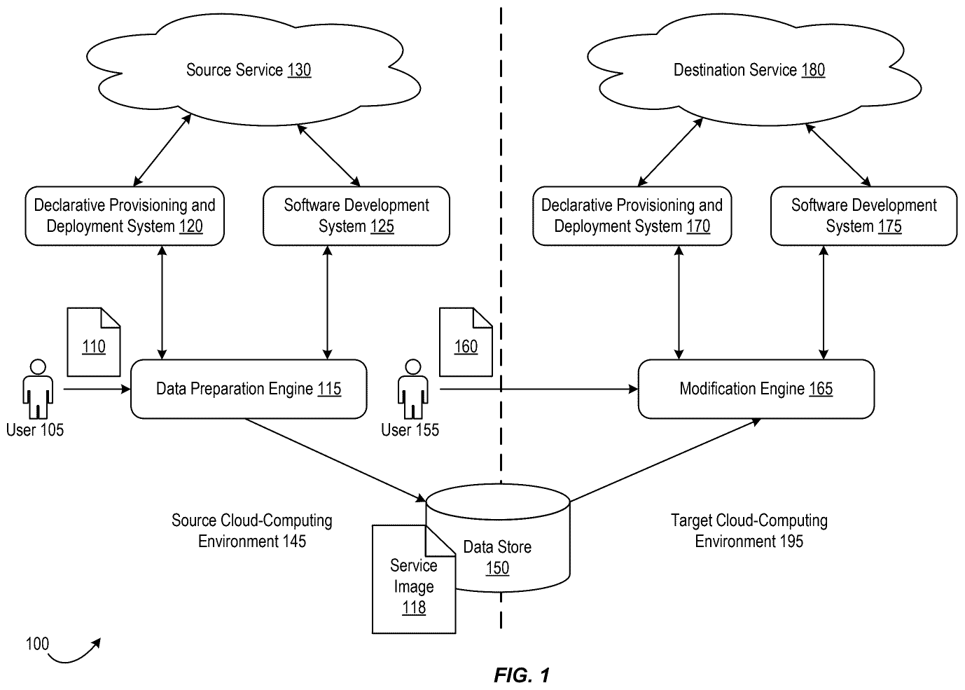

FIG. 1 depicts a block diagram illustrating a cloud computing environment for implementing the present disclosure, according to at least one embodiment. Cloud-computing environment 100 may include source cloud-computing environment 145 and target cloud-computing environment 195. Source cloud-computing environment 145 may be the source environment at which the services and resources are serialized, and a service image is created, and cloud-computing environment 195 may be the target environment at which the service is deployed.

Serialization involves converting cloud resources' configuration and runtime state into a structured format, creating comprehensive service images that can be stored and transported. On the other hand, deserialization involves reconstructing these services in a new environment based on the serialized data. Together, these processes ensure consistent and rapid deployment of services.

User 105 (e.g., in an automated manner or manually) may develop a serialize manifest (e.g., serialize manifest 110). The serialize manifest 110 may act as a blueprint or configuration file that describes the state and configuration of the resources within source cloud-computing environment 145 to be serialized. Serialize manifest 110 may include detailed information about the cloud resources, such as compute instances, network configurations, storage volumes, and any metadata (e.g., IP address, MAC address, etc.) that may be parameterized to make the metadata adaptable in a target environment (e.g., target cloud-computing environment 195). By way of example, serialize manifest 110 may include a compartment identifier, and image identifier, one or more parameter identifiers that identify a set of one or more attributes of metadata or service state that may be parameterized, or any suitable information related to the service image to be serialized. Serialize manifest 110 may be used by the data preparation engine 115 to capture and structure data to be included in the service image according to a standardized format (e.g., JSON, XML, etc.). The structured data (e.g., one or more attribute/value pairs) may be parameterized according to the serialize manifest 110. Parameterizing an attribute of the structured data may include replacing the attribute and the attribute's corresponding value with a parameter object that maintains the attribute/value and that indicates, via the presence of the parameter object, that the attribute's value is adaptable/modifiable in a target environment. The structured data, including any suitable parameterized data may be serialized and stored in the snapshot data store 150, from which it may be later retrieved used for future deployment. “Serializing” structured/parameterized data may include converting the data (or object the data represents) into a byte stream, string representation, or the like that can be easily stored or transmitted, but which also preserves the internal structure and data.

The source service 130 may include the cloud resources of a service that are described in the serialize manifest 110 and are subject to serialization. A current runtime state and configuration of these resources may be captured, processed and structured by the data preparation engine 115 to create a service image (e.g., service image 118). The service image may include all relevant information and parameterized values necessary for accurate and consistent deployment in target cloud-computing environment 195.

Source service 130 may include various components such as compute instances, network configurations, storage volumes, etc. These components may be referred to generally as “service resources.” Compute instances may encompass details about virtual machines, including their CPU, memory, and disk configurations. Network configurations provide information about virtual networks, subnets, routing tables, and security groups. Storage volumes may include data related to block storage, databases, and other storage resources. The manifest, or another suitable predefined parameterization list, may indicate particular data of the source service 130 that may be parameterized for adaptability when re-instantiated. By way of example, a predefined parameterization list may indicate which attribute/values (e.g., attributes/values corresponding to IP address(es) and/or MAC address(es)) are to be parameterized for deployment in target cloud-computing environment 195.

Data preparation engine 115 may send or invoke one or more queries at one or more resource managers to gather resource data about source service 130. In some embodiments, data preparation engine 115 may convert resource data into a structured format (e.g., JSON, XML, or another suitable markup language or key/value format), parameterize the structured data, and serialize the parameterized data to generate a serialized snapshot. Parameterizing the structured data may include replacing one or more attributes/values with a corresponding parameter object. In some embodiments, the data preparation engine 115 may utilize a predefined parameterization list to identify which, if any, attributes/values of the structured format are to be replaced with a parameter object. A parameter object may include any suitable combination of contextual data (e.g., timestamp data indicating a day/time at which the corresponding snapshot was taken, etc.), a current value of an attribute within source cloud-computing environment 145, or the like. The existence of a parameter object may be used to indicate attributes/values that are adaptable/modifiable with a target environment (e.g., target cloud-computing environment 195).

In some embodiments, serialize manifest 110 may include details of what data is collected and what subset of that data, if any, is to be parameterized, ensuring that the service image 118 accurately captures the runtime state and configuration of source service 130. During deserialization, deserialize manifest 160 may guide the reconstruction of source service 130 (e.g., destination service 180) in the target cloud-computing environment 195. Deserialize manifest 160 may specify how parameterized values should be replaced to allow all configurations to be correctly applied to maintain the intended behavior and performance of the original service.

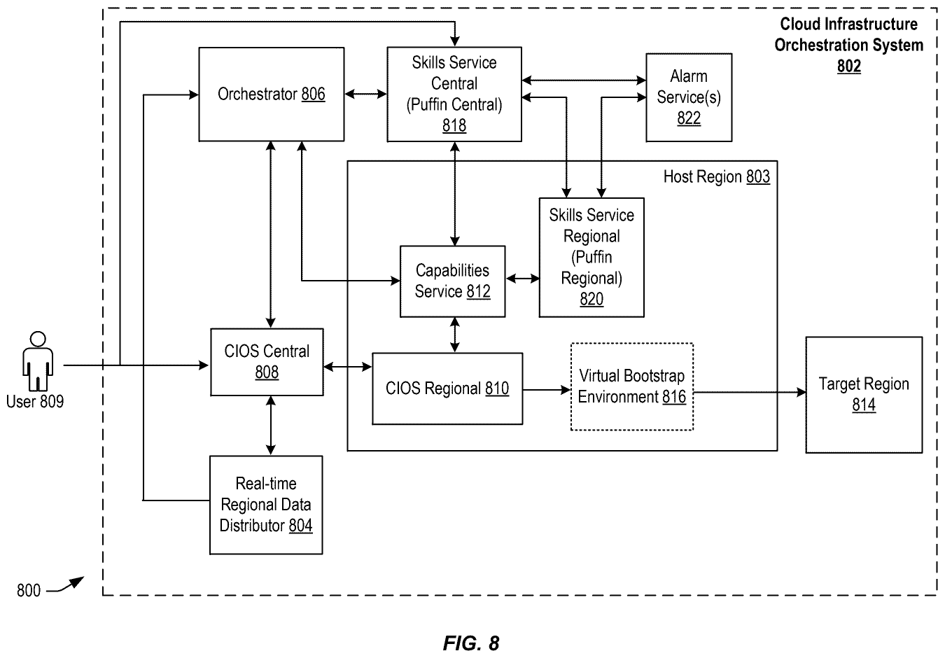

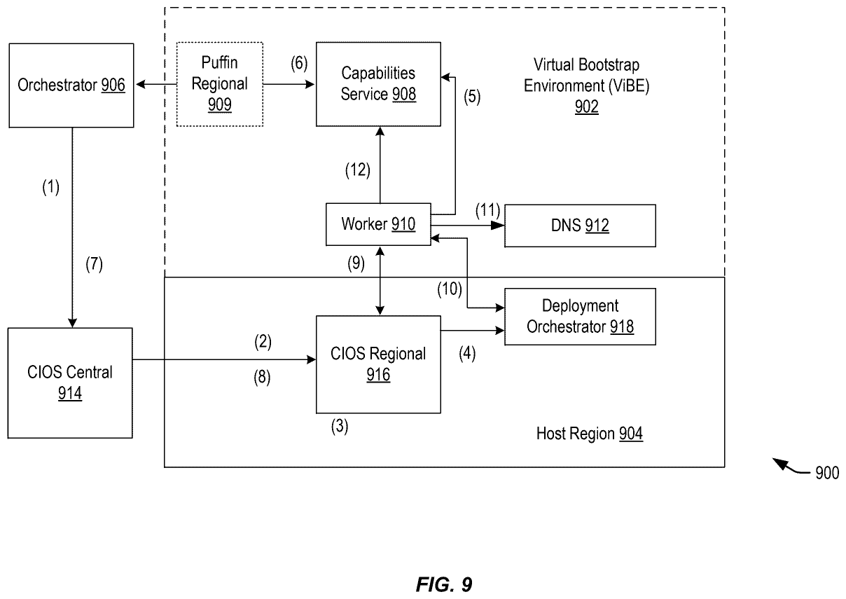

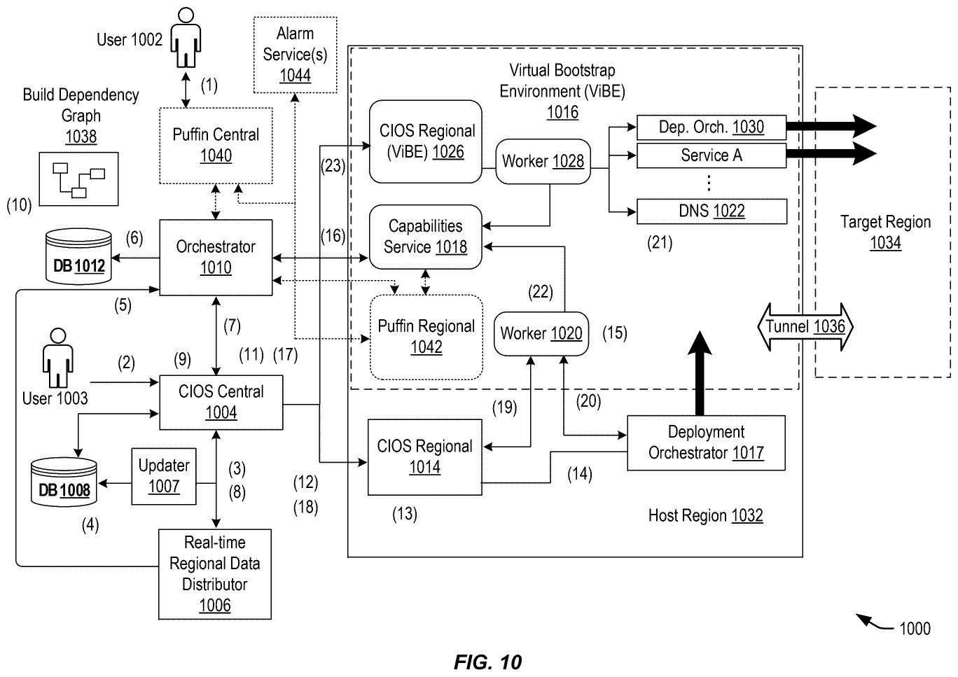

In some embodiments, declarative provisioning and deployment system 120 may be a tool used to manage and automate the provisioning of infrastructure and deployment of software within a cloud environment. User 105 may specify (e.g., via one or more configuration files) what the infrastructure and/or resources of a service should include rather than detailing the workflow to achieve that state. This description may include all the necessary resources, such as compute instances, networking components, and storage resources. The declarative provisioning and deployment system 120 may be used to parse these configuration files to identify resources to provision and deploy to bring the data plane resources of source cloud-computing environment 145, to bring the actual state in conformance with the desired state defined by the user. Declarative provisioning and deployment system 170 may be configured to serve a similar function within target cloud-computing environment 195. Declarative provisioning and deployment system 120 and 170 may individually be an example of CIOS regional 810 of FIG. 8, or an instance of declarative provisioning and deployment system 120 and/or 170 may be instantiated by CIOS regional 810, within a corresponding cloud environment. By way of example, an instance of declarative provisioning and deployment system 120 may execute at worker 910 of FIG. 9, worker 1020 of FIG. 10, etc. declarative provisioning and deployment system.

Data preparation engine 115 may gather information from software development system 125. Software development system 125 may collect and provide state information on instances of services in the service image 118. Software development system 125 may ensure that the necessary tools and frameworks are available for defining, testing, and deploying services, thereby facilitating the accurate and comprehensive serialization of cloud resources.

Software development system 125 may integrate development tools and frameworks with the data preparation engine 115. This integration may allow for precise definition and validation of the service configurations. For example, software development system 125 may provide tools for managing dependencies, configuring network settings, and ensuring that security protocols are adhered to. By incorporating these tools, Software Development System 125 may allow capturing the complete state and configuration of the resources (e.g., source service 130), such as compute instances, network configurations, and storage volumes.

Once the data preparation engine 115 identifies service resources of the source service 130 utilizing the declarative provisioning and deployment system 120, data preparation engine 115 may utilize software development system 125 to collect configuration information and/or runtime state data for each of the identified services. Software development system 125 may be utilized to ensure that all configurations and states are accurate and complete. This involves validating the collected data, checking for consistency, and making any necessary adjustments to ensure the service image reflects the current state of the source service 130. In some embodiments, software development service 125 may identify and/or obtain any suitable images installed at the identified resources and/or any suitable data associated with or stored at the identified resources. The data preparation engine 115 may utilize the software development system 125 to collect images, stored data (e.g., block volumes), or any suitable runtime state data of the identified resources in order to include the serialized version of that data in the service image 118.

A service image (e.g., the service image 118, an example of a serialized snapshot), may encapsulate configurations and runtime state data that may be used to recreate/re-instantiate the service in a new environment (e.g., target cloud-computing environment 195). The service image may act as a point-in-time record that captures the current state of all relevant resources and configurations within a cloud service, including compute instances, network settings, storage volumes, and other critical components. The service image may include resource metadata for identified resources of source service 130, such as attributes associated with compute instances, network configurations, security groups, and other infrastructure elements. For example, it might capture a virtual machine's specific CPU and memory configurations, along with its associated network interfaces and security policies. In addition to configuration data, the snapshot may capture the current runtime state of the resources, such as the contents of storage volumes, current network connections, and running processes. This ensures that all data and transactions are preserved, allowing for accurate restoration or replication of the service. Using this comprehensive service image, data preparation engine 115 may enable the service to be quickly and accurately deployed elsewhere (e.g., target cloud-computing environment 195) or within the same compartment and/or region/data center (e.g., as part of a recovery process for the service). Data preparation engine 115 may collect, process, and structure data corresponding to the resources of source service 130, creating a comprehensive service image that facilitates rapid and consistent deployment across different environments (e.g., target cloud-computing environment 195). In some embodiments, the target cloud-computing environment 195 may be the same compartment in the same region (e.g., the same data center within the region, a different availability domain within the region, for recovery purposes, etc.), a different compartment in the same region, across different regions (e.g., during a region build of target region 814 of FIG. 8, etc.), or the like.

Service images may be used for various purposes, including service restoration, replication, testing, and development. In disaster recovery scenarios, service images may be used to restore a service to a previous state, reducing downtime and data loss. They also may enable the replication of services across different environments, ensuring consistency and reducing deployment time. For instance, a service image taken in one data center can replicate the service in another, facilitating seamless expansion or migration. Additionally, snapshots provide a reliable way to create testing and development environments that mirror production, allowing developers to test new features or debug issues in an environment identical to production.

The source service 130 may be instantiated as destination service 180 within target cloud-computing environment 195 using service image 118 and a deserialization process. The deserialization process may involve several components, each performing specific roles and interacting with one another to achieve the successful provisioning and deployment of destination service 180 as specified by the service image 118. A deserialization manifest (e.g., deserialization manifest 160) may include necessary metadata, instructions, and configurations required for descrialization, specifying the format/structure of the serialized snapshot (e.g., service image 118). This may include the order and type of attributes and/or parameters/object of the serialized snapshot and their corresponding values. In some embodiments, the deserialization manifest 160 may identify parameters and/or parameter objects or other suitable placeholders to be replaced.

Modification Engine 165 may orchestrate the deserialization process. It may receive deserialization manifest 160 from user 155 and query data store 150 to obtain the corresponding service image (e.g., service image 118). With the service image retrieved, modification engine 165 may interact with the declarative provisioning and deployment system 170 and the software development system 175 to deploy and configure the destination service 180.

Software development system 175 may be utilized to specify configurations and runtime parameters for the resources of destination service 180. This may include environment variables, runtime settings, and other instance-specific configurations. Modification engine 165 may interact with software development system 175 to obtain and apply these runtime parameters during deserialization. Software development system 175 may supply the necessary configurations to the instances of services 180 being deployed. In some embodiments, modification engine 165 may utilize software development system 175 to make one or more application programming interface calls to generate environment specific attribute values with which parameter objects of the service image 118 may be replaced. This might involve replacing parameter objects (e.g., objects corresponding to IP addresses and/or MAC addresses) with values specific to the target cloud-computing environment 195. Additionally, the system supports runtime fix-ups and manual adjustments required for specific configurations during descrialization.

Declarative provisioning and deployment system 170 may define and provision the infrastructure resources required for the destination service 180. It may use a declarative approach to specify the interconnect and topology of resources, such as virtual networks, subnets, and other infrastructure components. Modification engine 165 may send requests to declarative provisioning and deployment system 170 to set up the resource topology based on the data provided in the service image 118.

In the deserialization process, the declarative provisioning and deployment system 170 may be invoked by the modification engine 165 to guide the provisioning and deployment of resources for the destination service 180 within the target cloud-computing environment 195 according to the serialized snapshot (e.g., service image 118) corresponding to that service. The declarative provisioning and deployment system 170 may call one or more APIs to provision infrastructure, create new virtual machines, configure network settings, apply security policies, install images, or the like, as indicated in the service image 118 retrieved from data store 150, including any suitable attributes and/or values that were used to replace parameterized objects of the service image 118. Declarative provisioning and deployment system 170 may execute any suitable instructions to ensure that the infrastructure and service resources of the target cloud-computing environment 195 are modified to be consistent with the resources, metadata, and state (e.g., a desired state) of the serialized snapshot, performing any necessary modifications and updates to bring the resources and runtime state of destination service 180 to conform to service image 118.

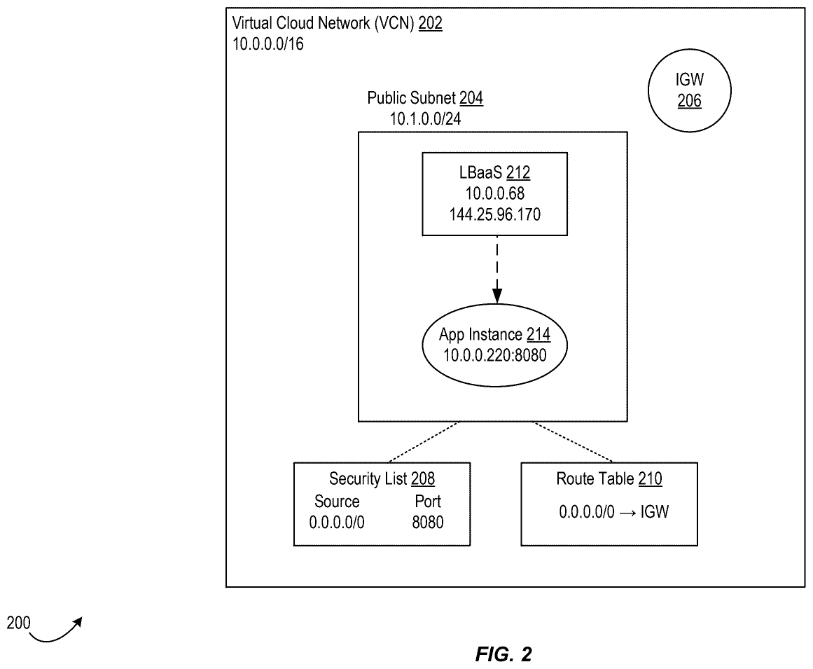

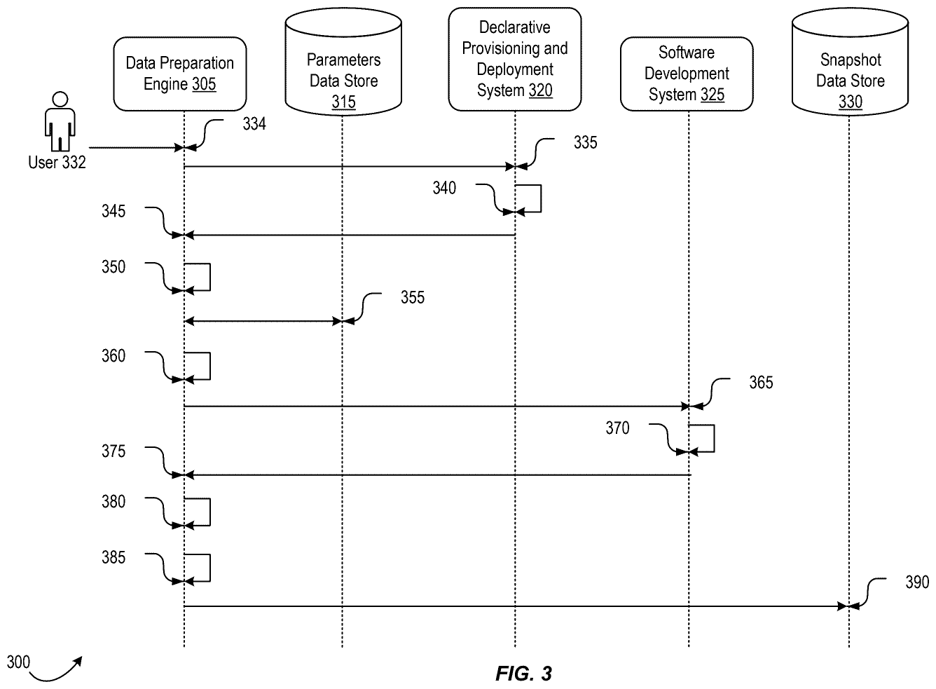

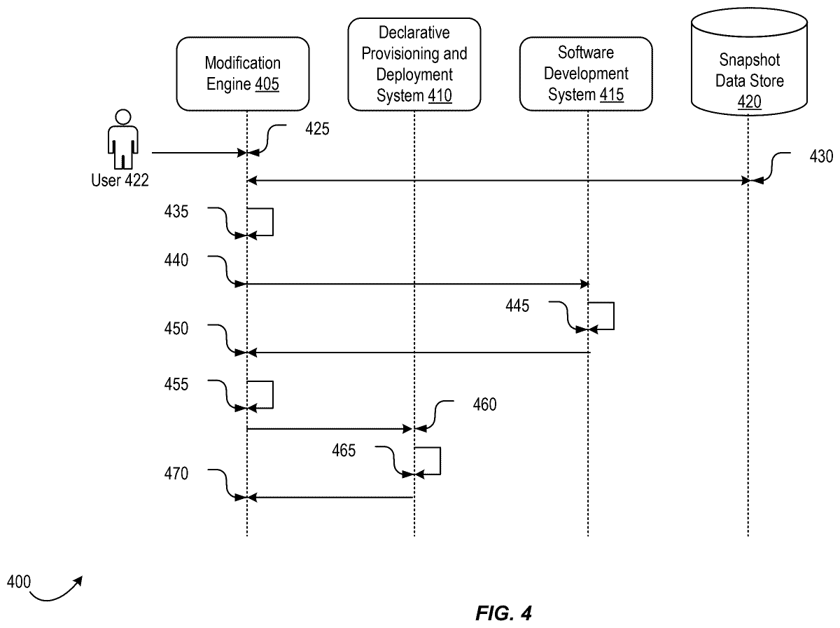

FIG. 2 illustrates an example service 200 for which a service image may be generated or used, according to at least one embodiment. The service 200 may include any suitable number and type of resources. For example, the service 200 of FIG. 2 is depicted as including a Virtual Cloud Network (VCN) 202 with an IP address range of 10.0.0.0/16. VCN includes a public subnet 204 with an IP address range of 10.1.0.0/24, an Internet Gateway (IGW) 206, a security list 208, and a route table 210. The security list 208, as depicted, includes an egress rule allowing traffic from any source address (as indicated with “0.0.0.0/0”) over a particular port number (e.g., 8080). The routing table 210, as depicted, includes a routing from any source address (0.0.0.0/0) to the IGW 206. The public subnet 204 of the example of FIG. 2 includes a load balancing as a service (LBaaS) process (e.g., LBaaS 212) with private IP address of 10.0.0.68, and a public IP address of 144.25.96.170 and an app instance (e.g., app instance 214) with a private IP address of 10.0.0.220, and a designated port of 8080. The use case depicted in FIG. 2 may be utilized for the purpose of providing a specific example with respect to the serialization and deserialization processes described in connection with FIGS. 3 and 4.

FIG. 3 illustrates an operation diagram illustrating an example method 300 for generating a serialized snapshot of a service, according to at least one embodiment. The serialization method 300 may be performed by data preparation engine 305 (e.g., data preparation engine 115 of FIG. 1), parameters data store 315, declarative provisioning and deployment system 320 (e.g., declarative provisioning and deployment system 120 of FIG. 1), software development system 325 (e.g., software development system 125 of FIG. 1), and snapshot data store 330 (e.g., data store 150 of FIG. 1).

The data preparation engine 305 may be configured to process and organize system configuration and state data into a structured format, incorporating metadata sourced from configuration files, runtime environments, and infrastructure components (e.g., of data plane) to facilitate accurate serialization of a service image (e.g., service image 118 of FIG. 1).

Parameters data store 315 may be configured to hold environment-specific, predefined parameterization data that may be used to replace attributes and their corresponding to values with placeholders (e.g., parameter objects) during the serialization process 300. These placeholders may be used to identify attributes for which modification is supported within a target environment.

Declarative provisioning and deployment system 320 may be an example of declarative provisioning and deployment system 120 in FIG. 1. Declarative provisioning and deployment system 320 may be configured to define and provision the infrastructure resources required for the services by specifying the interconnect and topology in a structured format. It may automate the setup of components or resources based on the serialized configuration.

Software development system 325 may be an example of software development system 125 in FIG. 1. The software development system 325 may be configured to provide specific configurations and runtime parameters for service resources, including environment variables and runtime settings.

Snapshot data store 330 may be an example of data store 150 in FIG. 1. Snapshot data store 330 may be configured to store serialized snapshots of system configurations and states, including metadata and captured runtime information. These snapshots are used during deserialization to rehydrate and accurately deploy the system components in the target environment. In some instances, the snapshot may be the service image.

The method 300 may being at 334, when user 332 (e.g., user 105 of FIG. 1) transmits (e.g., via a computing device, not depicted) a serialization request (also referred to as “a request,” for brevity) for a snapshot/service image. The request may include a serialize manifest. It may serve as a blueprint for serialization, by specifying data to be associated and/or included in the snapshot/service image. In some embodiments, the serialize manifest may specify one or more parameterizations (e.g., attributes to be replaced with parameter objects, attributes to be removed, etc.). In some embodiments, the serialize manifest may specify a compartment identifier and/or an instance identifier corresponding to the image source. The request and/or the manifest may indicate the service for which the snapshot/service image is to be generated.

At 335, receipt of the request (e.g., a request including a service manifest) may trigger the declarative provisioning and deployment system 320 to gather information about the required resources. By way of example, data preparation engine 305 may, in response to receiving the request at 334, transmit one or more queries to declarative provisioning and deployment system 320. The query/queries may individually include any suitable data obtained from the serialize manifest such as compartment identifier. In some embodiments, the data preparation engine 305 may transmit any suitable number of queries directly to any suitable number of resource providers (not depicted) to obtain respective sets of resource identifiers from each resource manager. In some embodiments, data preparation engine 305 transmits a single query that indicates compartment and service identifiers for which corresponding resources are to be identified.

At 340, declarative provisioning and deployment system 320 (e.g., a worker process executing an instance of Terraform) may be configured to receive this query and execute any suitable number of application programming interface calls to one or more resource managers (e.g., services that are configured to manage resources of a particular type of resource such as a compute service that manages compute resources, a block storage service that manages block storage resources, etc.) to obtain resource data corresponding to any suitable number of resources associated with the service and/or compartment.

At 345, the data by the declarative provisioning and deployment system 320 (e.g., from one or more resource managers) may be returned to the data preparation engine 305 for further processing.

At 350, data preparation engine 305 may perform any suitable operations for converting the raw data associated with the discovered resources and received from the declarative provisioning and deployment system 320 to any suitable structure format. By way of example, the raw data received at 345 may be converted to a markup language such as JSON, XML, or the like, or any suitable key/value format.

At 355, as the data preparation engine 305 processes the data, it may interact with the parameters data store 315 to identify a predefined list of attributes that are potentially adaptable (e.g., modifying the attribute within a new environment is supported), such as IP addresses and MAC addresses. In some embodiments, the serialize manifest may include the list of attributes that are potentially adaptable. Therefore, in some embodiments, the operations described at 355 may additionally be performed using the serialize manifest received at 334 to identify at least one of the attributes that are potentially adaptable. In some embodiments, all of the attributes that are potentially adaptable may be identified from the serialize manifest, in which case, the parameters data store 315 may not be consulted.

At 360, the data preparation engine 305 may replace each of the attributes identified at 355 (e.g., attributes identified from the parameters data store 315 or the serialize manifest as described above) with an object (also referred to herein as a “parameter object”). The object may include any suitable number of attributes and corresponding values. By way of example, upon identifying at 355 that the attribute “IP address” is potentially modifiable, the data preparation engine 305 may replace the attribute/value pair corresponding to the IP address with an object. This object may maintain the original value of the IP address. In some embodiments, the object may include one or more attributes corresponding to any suitable data related to the IP address and/or the snapshot (e.g., contextual information such as a timestamp corresponding to a time at which the snapshot of the service was requested and/or generated).

At 365, data preparation engine 305 may interact with (e.g., transmit a request to) the software development system 325 to capture any suitable metadata and/or parameters associated with the resources received/identified at 345. In some embodiments, the data preparation engine 305 may transmit a list of the resources received/obtained at 345 to the software development system 325.

At 370, software development system 325 may recursively process the data (e.g., the list) provided by data preparation engine 305, to collect configuration and/or state data for each resource provided in the list (e.g., each resource received/identified at 345). This may include collecting images, software, and/or workloads currently executing at each resource, data stored at the resource (e.g., a block volume), or the like from any suitable source from which such data is accessible. Obtaining such data may include executing any suitable number of application programming interfaces. Software development system 325 may validate the collected data, check for consistency, or make any necessary adjustments to ensure the snapshot/service image reflects the current state of each the resources of the service.

At 375, software development system 325 may return the collected data to data preparation engine 305 for serialization.

At 380, after data preparation engine 305 collects all the information from declarative provisioning and deployment system 320 and software development system 325, and it may recursively review and process the collected data to capture all required configurations and state information. This step may include examining the data to identify any remaining values that need to be parameterized or adjusted. In some embodiments, data preparation engine 305 may refer to the serialize manifest to identify snapshot data from the collected data (e.g., a subset, all, etc.). The serialize manifest may indicate what data is to be included in and/or excluded from the snapshot/service image. “Snapshot data” may refer to the portion of the collected data that is to be serialized/included in the snapshot/service image. This data may also be referred to as “service image data.”

At 385, data preparation engine 305 may initiate a process for serializing any suitable portion of the snapshot data. Serializing some or all of the snapshot data may include converting that portion of the snapshot data to a series of bytes.

At 390, data preparation engine 305 may store the snapshot data in the snapshot data store 330. Storing such data may be performed incrementally or otherwise. The stored snapshot data may be referred to as a “service image.”

At any suitable time, data preparation engine 305 may provide and/or cause status information to be presented (e.g., at a user device from which the request was initiated at 334) that identifies whether the snapshot/service image has been successfully created and/or stored.

Method 300 may be applied to the resources and metadata corresponding to FIG. 2. As a non-limiting example, a service snapshot/image may be requested. The request may include or correspond to a serialize manifest that indicates a compartment identifier associated with each of the components depicted in FIG. 2. The data preparation engine 305 may query (directly or indirectly through declarative provisioning and deployment system 320), via one or more queries, one or more resource managers to identify (e.g., by resource identifier) a set of one or more resources of the service and the resources' corresponding metadata. By way of example, the resources identified may include any suitable combination of VCN 202, Public subnet 204, IGW 206, security list 208, route table 210, LBaaS 212, and app instance 214. The resources of FIG. 2 may be identified using a set of resource identifiers. The metadata for those resources may include any suitable attribute or data that is associated with those resources/resource identifiers. In some embodiments, any suitable data associated with the identified resources may be converted to attribute/value pairs according to any suitable language or format (e.g., JSON, XML, etc.). The serialize manifest may be used to identify particular attributes (e.g., attribute/value pairs) that may be parameterized. As a non-limiting example, the IP addresses (individually corresponding to an attribute/value pair) depicted in FIG. 2 (or some subset) may be replaced with a corresponding parameter object that maintains the IP address of one environment (e.g., the cloud-computing environment from which service image is being generated) and indicates that the IP address may be modifiable in another environment (e.g., a target environment at which the service is to be re-instantiated). Each resource identifier may be used in one or more requests transmitted to software development system 315 to identify any images, configuration, assets, runtime state data, stored data, or the like that are associated with each resource identifier. Any suitable combination of the resource metadata or the images, configuration, assets, runtime state data, stored data, or the like that are associated with each resource identifier may be serialized and stored as a service image corresponding to a service that is associated with the compartment identifier.

FIG. 4 illustrates an operation diagram illustrating an example method 400 or deserializing a service image and instantiating a service in a target cloud-computing environment using the deserialized service image, according to at least one embodiment. The method 400 may be performed by modification engine 405 (e.g., modification engine 165 of FIG. 1), declarative provisioning and deployment system 410 (e.g., declarative provisioning and deployment system 170 of FIG. 1), software development system 415 (e.g., software development system 175 of FIG. 1), and snapshot data store 420 (e.g., data store 150 of FIG. 1).

Modification engine 405 may be an example of modification engine 165. Modification engine 405 may orchestrate the deserialization process of a service image obtained from snapshot data store 420 based on a deserialize manifest (e.g., deserialize manifest 160 of FIG. 1). It may coordinate with declarative provisioning and deployment system 410 and software development system 415 to provision, deploy, and configure services according to corresponding service images.

Declarative provisioning and deployment system 410 may provision the infrastructure resources required for the services, specifying the interconnect and topology of resources in a structured format. It may deploy artifacts and/or software to resources such as virtual networks, subnets, gateways, and other components based on the data provided by the modification engine 405.

Software development system 415 may be used to generate runtime parameters needed for the service, including environment variables and runtime settings.

Snapshot data store 420 may store serialized snapshots (e.g., service images) generated by the data preparation engine 115 of FIG. 1. These snapshots/service images may be used during deserialization to instantiate the service in the target environment (e.g., target cloud-computing environment 195 of FIG. 1) according to the snapshot/service image such that the service in the target environment is brought to the same state of the service when the snapshot/service image was generated.

Method 400 may begin at 425, when user 422 (e.g., user 155 of FIG. 1) provides (e.g., via a user device, not depicted) a deserialize manifest (or a request including a deserialize manifest) to data preparation engine 405. In some embodiments, the deserialize manifest may be provided or otherwise identified in a request. For example, a deserialize request may indicate a snapshot/service image identifier. This identifier may be obtained from the request via a deserialize manifest that is received in the request, or the deserialize manifest may be retrieved from a separate source (not depicted) based at least in part on being associated with the snapshot/service image identifier. The deserialize manifest (e.g., deserialize manifest 160 of FIG. 1) may serve as a blueprint (e.g., a schema) for identifying the specific data included in serialized data (e.g., a snapshot/service image stored in snapshot data store 420).

At 430, modification engine 405 may retrieve the snapshot/service image corresponding to the snapshot/service image identifier obtained at 425 (e.g., from the request and/or from the deserialize manifest).

At 435, modification engine 405 may use the deserialize manifest to deserialize/convert the serialized data of the snapshot/service image. The deserialized/converted data may include attribute/value pairs and/or parameter objects that correspond to attributes (e.g., objects that maintain the value of the attribute when the snapshot/service image was generated and/or any other suitable data such as a time when the snapshot was generated) of one or more resources. In some embodiments, the deserialized/converted data may include any suitable image, durable asset data (block storage content, object storage content, etc.), or the like corresponding to one or more resources associated with the service that is being instantiated in the environment.

At 440, modification engine 405 may identify each parameter object in the converted data. These objects may identify attributes which may be modifiable. In some embodiments, a predefined rule set may be used to determine whether to use the value of the attribute when the snapshot was taken as identified from the parameter object or generate a new value for the attribute. By way of example, when the compartment identifier corresponding to the service image matches the compartment identifier in which the service is to be instantiated (identified in the request), the predefined rule set may identify that the attribute/value of the snapshot is to be used. In this case, the operations discussed below in connection with software development system 415 may not be executed for the attribute. Conversely, if the compartment identifiers do not match, the predefined rule set may be used to determine that a new value is to be generated for the attribute in the environment in which the service is to be instantiated. The modification engine 405 may execute a call to the software development system 415 using any suitable function call, method call, application programming interface, or the like to request a value be generated for a given attribute. As a non-limiting example, upon determining from a parameter object and a predefined rule set that a new IP address is to be generated for an attribute of a resource, the modification engine 405 may execute a call to software development system 415 to request a new IP address. In some embodiments, modification engine 405 may utilize any suitable function call, method call, and/or application programming interface to provide, to software development system 415, any suitable image, runtime state data, durable data (e.g., block storage volume content, boot volume identifier and/or content), environmental variable, or the like that has been identified from the snapshot/service image as converted.

At 445, software development system 415 may execute any suitable function call, method call, and/or application programming interface to invoke any suitable functionality accessible within the environment (e.g., target cloud-computing environment 195) to generate or otherwise assign a value corresponding to the request received. In some embodiments, functionality of the software development system 415 may be invoked by the modification engine 405 to store any suitable image, runtime state data, durable data, environmental variables, or the like that was obtained by deserializing/converting the snapshot/service image according to the deserialize manifest. By way of example, any suitable number of images corresponding to any suitable resource identified in the deserialized/converted data.

At 450, software development system 415 may return any suitable generated/identified resource metadata, environment variables, runtime settings, or other configurations requested by the modification engine 405.

At 455, if new values for resource metadata were previously requested, modification engine 405 may overwrite any parameter object of the service image with the corresponding attribute and the value obtained from software development system 415 at 450. Operations described in connection with 440-455 may be performed any suitable number of times in order to replace each parameter object with an attribute and a value that corresponds to the environment with which the service is being instantiated (e.g., target cloud-computing environment 195).

At 460, modification engine 405 may provide the data as modified at 455 to the declarative provisioning and deployment system 410. By way of example, the modification engine 405 may be configured to provide attributes and values corresponding to any suitable number of resources. In some embodiments, modification engine 405 may not provide images, durable data, environmental variables, or the like, which have already been provided to the software development system 415.

At 465, declarative provisioning and deployment system 410 may be configured to generate resources based at least in part on the attributes/values provided at 460. In some embodiments, declarative provisioning and deployment system 410 (e.g., an example of the declarative provisioning and deployment systems 120 and 170 of FIG. 1, each an example of Terraform) may be configured to bring the current state of the environment (e.g., the state of control plane and/or data plane resources of the environment) to a desired state indicated by the attributes/values provided at 460. In some embodiments, bringing the current state of the environment to the desired state may include any suitable combination of provisioning infrastructure resources and deploying artifacts and/or software to the provisioned infrastructure resources.

At 470, modification engine 405 may receive status information from declarative provisioning and deployment system 410 that identifies whether the current state of environment has been successfully brought in line with the desired state expressed in the snapshot/service image.

Method 400 may be applied to the snapshot/service image generated in accordance with method 300 of FIG. 3 and corresponding to the resources and state of the resources corresponding to FIG. 2 at a time at which the snapshot/service image was generated. As a non-limiting example, a service snapshot/service image may be obtained (e.g., from the data store 150 of FIG. 1, not depicted in FIG. 4) based at least in part on receiving a request that indicates the snapshot/service image to be utilized. A deserialize manifest may be included in the request or retrieved from storage (e.g., snapshot data store 420) based at least in part on an association to the service corresponding to the snapshot/service image. The modification engine 405 may convert and/or interpret the serialized data of the snapshot/service image according to the deserialize manifest. This conversion may convert the snapshot/service image into any suitable combination of attribute/value pairs and/or parameter objects corresponding to resource metadata associated with any suitable number of resources, as well as any suitable combination of images, runtime state data, environment variables, volume content, etc. that correspond to those resources. By way of example, resource metadata, images, runtime state data, environment variables, volume data, or the like corresponding to VCN 202, Public subnet 204, IGW 206, security list 208, route table 210, LBaaS 212, and app instance 214 of FIG. 2. A predefined rule set may be utilized to identify which parameter objects are to be replaced with newly generated values corresponding to the current environment. As a non-limiting example, parameter objects corresponding to the IP addresses depicted in FIG. 2 (or some subset) may be replaced with a new IP address generated for the current environment (e.g., the target cloud-computing environment within which the service corresponding to the snapshot/service image is to be instantiated). To generate these IP addresses, modification engine 404 may transmit any suitable number of requests to any suitable resource manager (directly, or via software deployment system 115) to request new IP addresses for each resource. Once returned, attributes and corresponding values for each IP address corresponding to each parameter object to be replaced may be used to replace the corresponding parameter object. If the predefined rule set does not identify the parameter object as needing a value corresponding to the new environment, that parameter object may be replaced with an attribute/value pair initially maintained in the parameter object and corresponding to the attribute/value obtained from the environment from which the snapshot/service image was generated, at a time at which the snapshot/service image was generated. Any images, configuration, assets, runtime state data, stored data, or the like that are associated with each resource may be provided to the software development system 115 to be stored (e.g., via one or more resource managers) at data stores corresponding to the same. The attribute/value pairs corresponding to the resource metadata may be provided to the declarative provisioning and deployment system 410. The declarative provisioning and deployment system 410 may be configured to generate resources based at least in part on the attributes/values. By way of example, the declarative provisioning and deployment system 410 may execute any suitable infrastructure and/or application release to provision infrastructure resources and/or deploy any suitable artifact and/or software to the provisioned infrastructure. As a non-limiting example, the declarative provisioning and deployment system 410 (e.g., a worker process executing an instance of Terraform) may provision infrastructure resources corresponding to VCN 202, Public subnet 204, IGW 206, 210, LBaaS 212, and app instance 214 of FIG. 2. In some embodiments, declarative provisioning and deployment system 410 may be configured to execute any suitable number of application releases to deploy images to those resources and/or to deploy security list 208 and/or route table 210. Through these infrastructure and/or application releases, declarative provisioning and deployment system 410 may bring the current state of the environment (e.g., the state of control plane and/or data plane resources of the environment) to a desired state indicated by the provided attributes/values. In this manner, the service corresponding to the resources and artifacts of FIG. 2 may be instantiated within a new environment to a state that corresponds to the state of the service in the environment from which the snapshot/service image was generated, at a time at which the snapshot/service image was generated. The new environment may correspond to a different compartment or region than the compartment or region from which the snapshot/service image was generated, or the new environment may be the same compartment/region from which the snapshot/service image was generated (e.g., in a recovery scenario in which the service is being re-instantiated in the same environment).

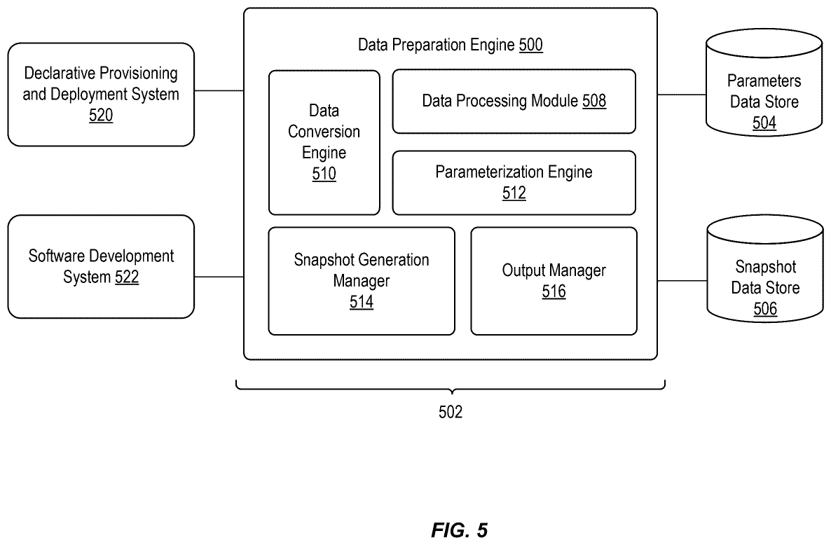

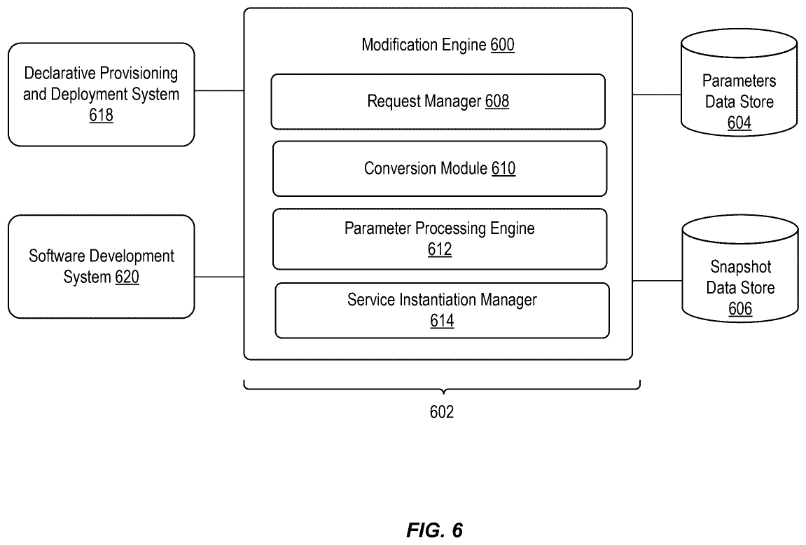

FIG. 5 illustrates a schematic diagram illustrating an example computer architecture for a data preparation engine (e.g., data preparation engine 500, an example of data preparation engine 115 of FIG. 1), according to at least one embodiment. The data preparation engine 500 may include a plurality of modules 502 that may perform functions in accordance with at least one embodiment. In data preparation engine 500 may be configured to support the processes, methods, operations, and techniques described above in connection with the data preparation engines of FIGS. 1 and 3. The modules 502 may be software modules, hardware modules, or a combination thereof. If the modules are software modules, the modules can be embodied on a computer readable medium and processed by a processor in any of the computer systems described herein. It should be noted that any module or data store described herein, may be, in some embodiments, be a service responsible for providing functionality corresponding to the module described below. The modules 502 may be execute as part of the data preparation engine 500, or the modules 502 may exist as separate modules or services external to the data preparation engine 500. In some embodiments, the modules 502 may be executed by the same or different computing devices, as a service, as an application, or the like. In some embodiments, any suitable combination of the modules 502 may be combined in any suitable manner. In some embodiments, the functionality of data preparation engine 500 may be combined with the functionality of the modification engine 600 of FIG. 6 in any suitable manner and this combined functionality may be provided by any suitable number of computing devices, services, applications, or the like.

In the embodiment shown in the FIG. 5, data stores accessible to the data preparation engine 500 may include parameters data store 504 (e.g., parameters data store 315 of FIG. 3) and snapshot data store 506 (e.g., snapshot data store 330 of FIG. 3) are shown, although data can be maintained, derived, or otherwise accessed from various data stores, either remote or local to the data preparation engine 500, to achieve the functions described herein. The data preparation engine 500, as shown in FIG. 5, includes various modules such as data processing module 508, data conversion engine 510, parameterization engine 512, snapshot generation manager 514, and output manager 516. Some functions of the modules 508-516 are described below. However, for the benefit of the reader, a brief, non-limiting description of each of the modules is provided in the following paragraphs. In accordance with at least one embodiment, a process validating existence of an anomaly and/or for identifying a source of an anomaly is provided.

The data processing module 508 may be configured to receive serialization/snapshot/service image requests and initiate a corresponding serialization process. In some embodiments, the requests may include a corresponding serialize manifest (e.g., the serialize manifest 110 of FIG. 1). If receive in a request, the serialize manifest may be stored in parameters data store 504 or another suitable storage location accessible to the data preparation engine 500.

In some embodiments, the data processing module 508 may be configured to gather data from various cloud resource managers either by submitting one or more requests to declarative provisioning and deployment system 520 (e.g., declarative provisioning and deployment system 120 of FIG. 1) and/or by directly submitting a request to one or more corresponding resource managers. Data processing module 508 may receive any suitable resource metadata (e.g., a resource identifier and/or any data associated with an infrastructure resource/application resource) in response to a previously transmitted request to declarative provisioning and deployment system 510. For example, it may collect any suitable resource metadata about compute instances, load balancers, virtual networks, block storage volumes, boot volumes, network configurations, configuration files, images, or the like corresponding to an infrastructure resource or an application resource of a particular environment (e.g., the source cloud-computing environment 145 of FIG. 1). The data processing module 508 may invoke the functionality of the data conversion engine 510 (e.g., via function call, method call, application programming interface call, or the like).

Data conversion engine 510 may be configured to obtain the raw data collected by the data processing module 508 and convert it into a structured format (e.g., JSON, XML, etc.). This conversion may structure the data into attribute/value pairs (also known as “key-value pairs) according to any suitable predefined conversion process. Data conversion engine 510 may be configured to pass the converted data to parameterization engine 512 for further processing.

Parameterization engine 515 may be configured to identify (e.g., according to a predefined rule set and/or the serialize manifest received by data processing module 508 and/or obtained from parameters data store 504) one or more attributes of the converted data for which modification is to be supported within a new environment in which the snapshot/service image is to be used to instantiate a service (also referred to as a deserialization environment). This may involve identifying potentially modifiable attributes and replacing each of them with a corresponding parameter object. Each parameter object may be configured to maintain the original attribute value of the environment in which serialization was initiated. In some embodiments, the parameter object may maintain any suitable data related to the attribute, its original value, and/or the snapshot. By way of example, the parameter object may be configured to maintain a timestamp at which the snapshot was initiated and/or completed.

The snapshot generation manager 514 may be configured to obtain the converted and/or parameterized data from data conversion engine 510 and/or parametrization engine 512. In some embodiments, data conversion engine 510 and/or parametrization engine 512 may invoke the functionality of snapshot generation manager 514. In some embodiments, the snapshot generation manager 514 may be configured to invoke the functionality of software development system 522 (e.g., software development system 125 of FIG. 1) to obtain any suitable image, runtime state, durable asset content (e.g., boot and/or block volume content), or the like corresponding to any suitable number of resources (e.g., corresponding to the resource identifiers obtained by the data processing module 508). In some embodiments, the snapshot generation manager 514 may be configured to serialize any suitable resource metadata, attributes, parameter objects, images, runtime state, durable asset content, and/or any suitable data generated by any suitable combination of the modules 502 or obtained from declarative provisioning and deployment system 520 and/or software development system 522.

The output manager 516 may be configured to provide (e.g., via any suitable electronic communication and/or interface) status information corresponding to the request received by the data processing module 508.

FIG. 6 illustrates a schematic diagram illustrating an example computer architecture for a modification engine (e.g., modification engine 600, an example of modification engine 165 of FIG. 1), according to at least one embodiment. The modification engine 600 may include a plurality of modules 602 that may perform functions in accordance with at least one embodiment. In modification engine 600 may be configured to support the processes, methods, operations, and techniques described above in connection with the modification engines of FIGS. 1 and 4. The modules 602 may be software modules, hardware modules, or a combination thereof. If the modules are software modules, the modules can be embodied on a computer readable medium and processed by a processor in any of the computer systems described herein. It should be noted that any module or data store described herein, may be, in some embodiments, be a service responsible for providing functionality corresponding to the module described below. The modules 602 may be execute as part of the modification engine 600, or the modules 602 may exist as separate modules or services external to the modification engine 600. In some embodiments, the modules 602 may be executed by the same or different computing devices, as a service, as an application, or the like. In some embodiments, any suitable combination of the modules 602 may be combined in any suitable manner. In some embodiments, the functionality of modification engine 600 may be combined with the functionality of the data preparation engine 500 of FIG. 5 in any suitable manner and this combined functionality may be provided by any suitable number of computing devices, services, applications, or the like.

In the embodiment shown in the FIG. 6, data stores accessible to modification engine 600 may include parameters data store 604 (e.g., parameters data store 315 of FIG. 3) and snapshot data store 606 (e.g., snapshot data store 330 of FIG. 3) are shown, although data can be maintained, derived, or otherwise accessed from various data stores, either remote or local to the modification engine 600, to achieve the functions described herein. The modification engine 600, as shown in FIG. 6, includes various modules such as request manager 608, conversion module 610, parameter processing engine 612, and service instantiation manager 614. Some functions of the modules 608-614 are described below. However, for the benefit of the reader, a brief, non-limiting description of each of the modules is provided in the following paragraphs. In accordance with at least one embodiment, a process validating existence of an anomaly and/or for identifying a source of an anomaly is provided.

Request manager 608 may be configured to initiate the deserialization process by handling incoming requests for service deployment. In some embodiments, the request manager may receive a service deployment request (also referred to as a “deserialization request”). The service deployment request may include a deserialize manifest (e.g., deserialize manifest 160 of FIG. 1) or a deserialize manifest corresponding to the service and/or snapshot may be retrieved from parameter data store 604 or another suitable location. In some embodiments, the service deployment request may include a snapshot/service image identifier with which the manifest and/or the snapshot/service image may be retrieved. In some embodiments, the request manager 608 may retrieve the snapshot/service image from snapshot data store 606 (e.g., the data store 150 of FIG. 1). Request manager 608 may orchestrate the instantiation of a service from a snapshot/service image by invoking any suitable functionality of the modules 602. In some embodiments, when a new service deployment is requested, the request manager 608 may utilize the corresponding deserialize manifest to convert/interpret the serialized data of the snapshot/service image to convert the snapshot/service image to attribute/value pairs, parameter objects, images, volume data, and the like, according to the data specified in the manifest.

Conversion module 610 may retrieve the serialized data from the snapshot data store 606 and convert the serialized data to a structured format including attribute/value pairs, parameter objects, images, volume data, and the like, according to the data specified in the manifest. In some embodiments, the structured format may correspond to any suitable language (e.g., JSON, XML, etc.) or schema format.

The functionality of parameterization processing engine 612 may be invoked by any suitable combination of the modules 602 (e.g., by the request manager 608, the conversion module 610, or the like). In some embodiments, the parameterization processing engine 612 may be configured to identify and replace parameter objects identified within the data converted by conversion module 610 with values suitable and/or generated for the target environment. By way of example, the parameter processing engine 612 may be configured to invoke (e.g., via function call, method call, application programming interface, or the like) the functionality of software development system 620 (e.g., software development system 175 of FIG. 1) according to a predefined rule set. As a non-limiting example, a parameter object corresponding to an IP address may be identified (e.g., via the predefined rule set) as a parameter that is to be replaced with a newly generated value. The parameter processing engine 612 may invoke the functionality of software development system 620 to request a new IP address. Once returned, the parameter processing engine 612 may replace the parameter object with an attribute/value pair that identifies an IP address attribute with a value corresponding to the newly generated IP address. The parameter processing engine 612 may be configured to perform these operations any suitable number of times to replace any suitable number of parameter objects that are identified by the predefined rule set as needing to be replaced with a newly generated value. Parameter objects which are not identified as needing to be replaced by a newly generated value may be replaced with an attribute/value pair in which the value corresponds to the value initially maintained in the parameter object which corresponds to the value of the attribute in the environment from which the snapshot/service image was generated, at the time at which the snapshot/service image was generated.

Service instantiation manager 614 may be configured to provide, directly, or indirectly through the software development system 620, any suitable image, runtime state, volume data, asset, environment variables, or the like, to any suitable number of resource managers. These resource managers and/or the software development system 620 may be configured to store the received data at any suitable corresponding storage location within the environment in which the service is being instantiated. Service instantiation manager 614 may provide any suitable resource metadata corresponding to the attribute/value pairs to the declarative provisioning and deployment system 618. The declarative provisioning and deployment system 618 may be configured to generate resources based at least in part on the attributes/values. By way of example, the declarative provisioning and deployment system 618 may execute any suitable infrastructure and/or application release to provision infrastructure resources and/or deploy any suitable artifact and/or software to the provisioned infrastructure. As a non-limiting example, the declarative provisioning and deployment system 618 may provision a virtual machine and deploy an image to that virtual machine (e.g., once of the stored images previously provided to the declarative provisioning and deployment system 618 and identified within resource metadata corresponding to an application release). In some embodiments, declarative provisioning and deployment system 618 (e.g., a worker process executing an instance of Terraform) may be configured to bring the current state of the environment (e.g., the state of control plane and/or data plane resources of the environment) to a desired state indicated by the attributes/values. In some embodiments, bringing the current state of the environment to the desired state may include any suitable combination of provisioning infrastructure resources and deploying artifacts and/or software to the provisioned infrastructure resources. In this manner, the service may be instantiated within the environment to a state that corresponds to the state of the service in the environment from which the snapshot/service image was generated, at a time at which the snapshot/service image was generated. In some embodiments, the service instantiation manager 614 may provide any suitable status information (e.g., via any suitable user interface and/or electronic communication) indicating whether the service was successfully instantiated within the environment.

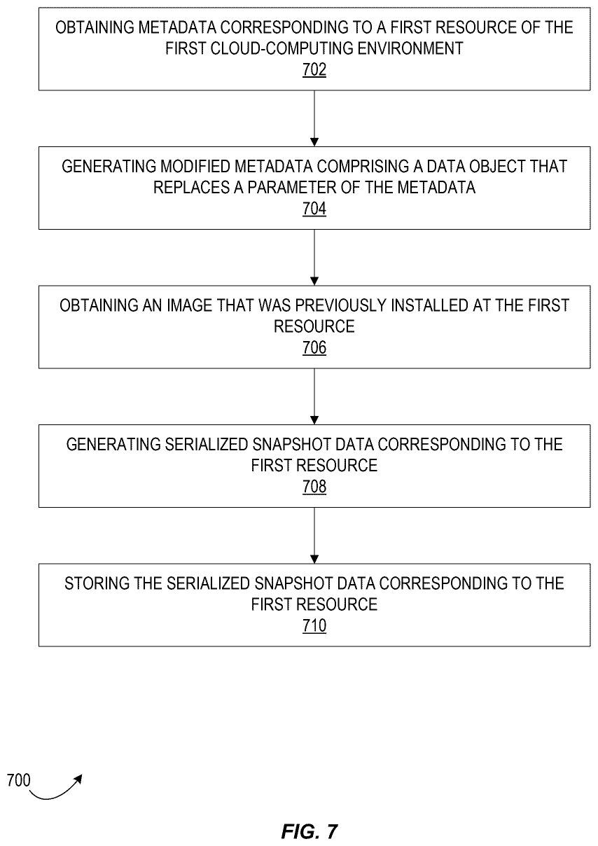

FIG. 7 is a block diagram illustrating generating a serialized snapshot, in accordance with at least one embodiment. Method 700 may be performed by any suitable combination of the modules 502 of FIG. 5. In some embodiments, method 700 may include more or fewer steps than the number depicted in FIG. 7. It should be appreciated that the steps of method 700 may be performed in any suitable order.

Method 700 may begin at 702, where metadata (e.g., resource metadata described in FIGS. 1-6) corresponding to a first data plane resource of a first cloud-computing environment (e.g., source cloud-computing environment 145 of FIG. 1) may be obtained (e.g., by the data processing module 508 of FIG. 5). In some embodiments, the metadata corresponding to the first data plane resource may be obtained from one or more resource managers (e.g., directly, or via a declarative provisioning and deployment system such as the declarative provisioning and deployment system 520 of FIG. 5). In some embodiments, the metadata may be obtained using any suitable combination of a function call, method call, or application programming interface.

At 704, modified metadata may be generated (e.g., by the data conversion engine 510 and/or the parameterization engine 512 of FIG. 5). In some embodiments, the modified metadata may be generated (e.g., by the data conversion engine 510 of FIG. 5) based at least in part on converting the metadata obtained at 702 to a predefined format or structure (e.g., JSON). In some embodiments, the modified metadata may be generated (e.g., by the parameterization engine 512) based at least in part on determining via a predefined rule set whether to replace any suitable portion of the metadata with a data object (e.g., a parameter object that maintains the attribute/value of the metadata in the source cloud-computing environment 145 and any suitable data associated with the attribute/value such as a time at which the serialized snapshot was requested and/or generated). As another example, the parameter being replaced (e.g., an attribute/value pair) may be identified according to a predefined parameterization specification (e.g., serialize manifest 110 of FIG. 1). By way of example, certain values like IP addresses, MAC addresses, or other environment-specific data may be replaced by parameter objects (data objects, placeholders, tokens, etc.) according to a predefined rule set. The existence of the parameter object in the serialized snapshot may indicate an attribute/value for which modification is supported. When the serialized snapshot is later deserialized and processed to instantiate a service in the target cloud-computing environment, the parameter object(s) may be replaced with a newly generated data value specific to the target cloud-computing environment based at least in part on a predefined rule set.

At 706, an image that was previously installed at the first data plane resource may be obtained. The compute system may obtain the image from a data store and/or the image may be obtained by transmitting a request for such information. In some embodiments, this request may be directed to software development system 125 of FIG. 1. In addition, or in lieu of the image, any suitable combination of current state data/runtime data, durable asset content such as block and/or boot volume content, stacks, environment variables, or the like may be similarly obtained by request to the software development system 125 of FIG. 1.

At 708, serialized snapshot data corresponding to the first data plane resource may be generated (e.g., by the snapshot generation manager 514 of FIG. 5). In some embodiments, the serialized snapshot data may comprise a plurality of data bytes generated from a combination of the image that was previously installed at the first data plane resource (and/or any suitable data obtained at 706) and the modified metadata comprising the data object that replaces the parameter of the metadata. In some embodiments, generating the serialized snapshot data may comprise serializing the modified metadata generated at 704 and the data obtained at 706, or in other words, generating an ordered set of bytes from the modified metadata generated at 704 and the data obtained at 706. In some embodiments, the serialized snapshot data comprises at least one of a snapshot identifier, a compartment identifier corresponding to the first data plane resource, a stack identifier, an image identifier, or a network address.

At 710, the serialized snapshot data corresponding to the first data plane resource may be stored (e.g., in data store 150 of FIG. 1, snapshot data store 506 of FIG. 5). In some embodiments, the serialized snapshot data enables a second data plane resource (e.g., a data plane resource associated with the service) to be configured, within a second cloud-computing environment (e.g., a data plane resource associated with the destination service 180 of the target cloud-computing environment 195), based at least in part on the first data plane resource of the first cloud-computing environment (e.g., the same data plane resource associated with the source service 130 of the source cloud-computing environment 145).

In some embodiments, the method 700 may further comprise identifying that the first data plane resource is associated with a storage resource type (e.g., a boot or block volume) and, in response to identifying that the first data plane resource is associated with the storage resource type, obtaining replicated data that replicates corresponding data stored at the first data plane resource, wherein the serialized snapshot data is generated to further comprise the replicated data.

In some embodiments, a request may be transmitted (e.g., by a user device) to the second cloud-computing system. The request may identify the serialized snapshot data. In some embodiments, transmitting the request causes the second computing system to configure the second cloud-computing environment with the first data plane resource according to the serialized snapshot data generated from the first data plane resource of the first cloud-computing environment. In some embodiments, the request may include a manifest (e.g., deserialize manifest 160 of FIG. 1). The manifest may comprise at least one of a compartment identifier, a stack identifier, an image identifier, or a network address. Transmitting the request may cause a component of the second cloud-computing environment to obtain the snapshot data and to configure the second data plane resource within the second cloud-computing environment.

In some embodiments, the first cloud-computing environment is a first compartment of a cloud-computing region/data center, and the second cloud-computing environment is a second compartment of the cloud-computing region/data center. In some embodiments, the first cloud-computing environment is associated with a first region/data center and the second cloud-computing environment is associated with a second region/data center.

In some embodiments, the data object of the modified metadata represents data that may be overwritten in accordance with corresponding data values associated with the second cloud-computing environment.

In some embodiments, the snapshot data is serialized prior to storage.

In some embodiments, a volume snapshot corresponding to the first data plane resource may be obtained where the volume snapshot corresponding to data stored at the first data plane resource. In some embodiments, the snapshot data further comprises the volume snapshot corresponding to the first data plane resource.

### Example Environments

The adoption of cloud services has seen a rapid uptick in recent times. Various types of cloud services are now provided by various cloud service providers (CSPs). The term cloud service is generally used to refer to a service or functionality that is made available by a CSP to users or customers on demand (e.g., via a subscription model) using systems and infrastructure (cloud infrastructure) provided by the CSP. Typically, the servers and systems that make up the CSP's infrastructure and which is used to provide a cloud service to a customer are separate from the customer's own on-premises servers and systems. Customers can thus avail themselves of cloud services provided by the CSP without having to purchase separate hardware and software resources for the services. Cloud services are designed to provide a subscribing customer easy, scalable, and on-demand access to applications and computing resources without the customer having to invest in procuring the infrastructure that is used for providing the services or functions. Various different types or models of cloud services may be offered such as Software-as-a-Service (SaaS), Platform-as-a-Service (PaaS), Infrastructure-as-a-Service (IaaS), and others. A customer can subscribe to one or more cloud services provided by a CSP. The customer can be any entity such as an individual, an organization, an enterprise, and the like.

As indicated above, a CSP is responsible for providing the infrastructure and resources that are used for providing cloud services to subscribing customers. The resources provided by the CSP can include both hardware and software resources. These resources can include, for example, compute resources (e.g., virtual machines, containers, applications, processors), memory resources (e.g., databases, data stores), networking resources (e.g., routers, host machines, load balancers), identity, and other resources. In certain implementations, the resources provided by a CSP for providing a set of cloud services CSP are organized into data centers. A data center may be configured to provide a particular set of cloud services. The CSP is responsible for equipping the data center with infrastructure and resources that are used to provide that particular set of cloud services. A CSP may build one or more data centers.

Data centers provided by a CSP may be hosted in different regions. A region is a localized geographic area and may be identified by a region name. Regions are generally independent of each other and can be separated by vast distances, such as across countries or even continents. Regions are grouped into realms. Examples of regions for a CSP may include US West, US East, Australia East, Australia Southeast, and the like.

A region can include one or more data centers, where the data centers are located within a certain geographic area corresponding to the region. As an example, the data centers in a region may be located in a city within that region. For example, for a particular CSP, data centers in the US West region may be located in San Jose, California; data centers in the US East region may be located in Ashburn, Virginia; data centers in the Australia East region may be located in Sydney, Australia; data centers in the Australia Southeast region may be located in Melbourne, Australia; and the like.

Data centers within a region may be organized into one or more availability domains, which are used for high availability and disaster recovery purposes. An availability domain can include one or more data centers within a region. Availability domains within a region are isolated from each other, fault tolerant, and are architected in such a way that data centers in multiple availability domains are very unlikely to fail simultaneously. For example, the availability domains within a region may be structured in a manner such that a failure at one availability domain within the region is unlikely to impact the availability of data centers in other availability domains within the same region.

When a customer or subscriber subscribes to or signs up for one or more services provided by a CSP, the CSP creates a tenancy for the customer. The tenancy is like an account that is created for the customer. In certain implementations, a tenancy for a customer exists in a single realm and can access all regions that belong to that realm. The customer's users can then access the services subscribed to by the customer under this tenancy.

As indicated above, a CSP builds or deploys data centers to provide cloud services to its customers. As a CSP's customer base grows, the CSP typically builds new data centers in new regions or increases the capacity of existing data centers to service the customers' growing demands and to better serve the customers. Preferably, a data center is built in close geographical proximity to the location of customers serviced by that data center. Geographical proximity between a data center and customers serviced by that data center lends to more efficient use of resources and faster and more reliable services being provided to the customers. Accordingly, a CSP typically builds new data centers in new regions in geographical areas that are geographically proximal to the customers serviced by the data centers. For example, for a growing customer base in Germany, a CSP may build one or more data centers in a new region in Germany.

Building a data center (or multiple data centers) in a region is sometimes also referred to as building a region. The term “region build” is used to refer to building one or more data centers in a region. Building a data center in a region involves provisioning or creating a set of new resources that are needed or used for providing a set of services that the data center is configured to provide. The end result of the region build process is the creation of a data center in a region, where the data center is capable of providing a set of services intended for that data enter and includes a set of resources that are used to provide the set of services.

Building a new data center in a region is a very complex activity requiring coordination between various service teams. At a high level, this involves the performance and coordination of various tasks such as: identifying the set of services to be provided by the data center, identifying various resources that are needed for providing the set of services, creating, provisioning, and deploying the identified resources, wiring the resources properly so that they can be used in an intended manner, and the like. Each of these tasks further have subtasks that need to be coordinated, further adding to the complexity. Due to this complexity, presently, the building of a data center in a region involves several manually initiated or manually controlled tasks that require careful manual coordination. As a result, the task of building a new region (i.e., building one or more data centers in a region) is very time consuming. It can take time, for example, many months to build a data center. Additionally, the process is very error prone, sometimes requiring several iterations before a desired configuration of the data center is achieved, which further adds to the time taken to build a data center. These limitations and problems severely limit a CSP's ability to grow in a timely manner responsive to increasing customer needs.

Bootstrapping operations have been coordinated and orchestrated by an orchestrator (e.g., a Multi-Flock Orchestrator, an orchestration service, etc.). In previous implementations, the orchestrator attempted to automatically detect dependencies between operations. The orchestrator utilized various versions of configuration files and/or software artifacts and attempted to intelligently and automatically identify the artifacts and manner in which a data center build was performed. As a data center was built, the orchestrator utilized capabilities (e.g., tags that could be toggled on or off to indicate availability of a resource or functionality) to drive these operations. However, both the automatic detection techniques and the use of capabilities included drawbacks.

Previous implementations of an orchestrator also lacked an exact plan of the work that may be needed (or is needed) to build a data center ahead of the actual build. The orchestrator utilized service build definitions that were spread across multiple flock configuration files (“flock configs”) and interpreted by the orchestrator at runtime. This caused the orchestrator to execute a non-predetermined number of releases, in a non-predetermined order, each of which published a non-predetermined number of capabilities per release. To compensate for this indeterministic behavior, manually curated micro-schedules were generated and used to track the work and order of operations necessary to build the data center. These micro-schedules were not machine executable nor derived from code. Service teams were not prevented from changing their build automation which could cause the existing micro-schedules to be invalidated. Additionally, it was not possible to determine exact behavior of a service build when configuration files for that service rely on external data.

In previous implementations, tasks were triggered by publishing capabilities. Capability availability was not held constant over a release leading to non-determinism in the planned activity if any optional capabilities were published mid-release. The use of optional capabilities made it difficult to determine when a release was expected to publish a certain capability of if a resource was ever going to be created. Service teams could also introduce changes that created unsatisfiable cyclic dependencies between services causing the build to deadlock or depend upon a capability that would never be published. For at least these reasons, it was impossible to determine when dependent releases would be unblocked. Heterogeneity in different regions also meant that there was no single plan for how a service should be bootstrapped. Rather, a different plan existed for each region furthering compounding the difficulty in understanding how the service is built, as capabilities might be depended upon or published in certain types of regions and not others.

Service plans and manifests (SPAMs) may serve as a deterministic specification for the bootstrapping process of a single service. A service plan and manifest (SPAM) provides a complete service build description that specifies the releases and the deterministic/explicit order of those releases that may be necessary (or are necessary) to build a service. The SPAM may include clear expectations for the progress expected by each transition (e.g., each release execution corresponding to a particular phase/execution target). One or more services (e.g., all services to be bootstrapped within the region) may be associated with a corresponding SPAM. Information provided by these SPAMs may be utilized to eliminate various errors that can occur in a data center build by identifying issues early in the build lifecycle (e.g., upon SPAM submission) rather than at build time. SPAMs may be composed together by an orchestrator (e.g., a Multi-Flock Orchestrator, a region orchestration service, etc.) and used to form a directed acyclic graph (DAG) of work (e.g., releases) that identifies the expected order of release executions that may be needed (or in some instances, is needed) to build the data center and capability dependencies between those releases. The defined graph may be pre-validated for abnormalities such as cycles on creation and on subsequent region updates. The graph may be used to support improved error detection both prior to and during a build. The graph generated from SPAMs may be used to drive region build operations and/or it may be used to validate a different graph (e.g., one generated from flock configs as in previous implementations) that is used to drive the region build. The SPAM provides a deterministic specification of a build implementation for a given service that reduces, if not eliminates, the non-deterministic drawbacks present in previous implementations that utilized multiple flock configs to identify the releases that may be needed (or is needed) to build a service. This improves observability and understanding of the region build and reduces the time and complexity of identifying root cause when an error is experienced during region build.

A “region” is a logical abstraction corresponding to a geographical location. A region can include any suitable number of one or more execution targets.

A “phase” refers to a group of execution targets that can be execute at the same time.

An “execution target” refers to a unit of change for executing a release. An execution target may be specific to a region and a tenancy. Execution targets may be aggregated into one or more phases. For some services, an execution target represents an “instance” of a service. A single service can be bootstrapped to each of one or more execution targets. An execution target may be associated with a set of devices (e.g., a data center).

A “release” refers to a representation of an intent to orchestrate a specific change to a service (e.g., deploy version 8, “add an internal DNS record,” etc.). In some embodiments, a release corresponds to an instance of infrastructure provisioning or application deployment. A release may target one or more phases or execution targets.

“Bootstrapping” is intended to refer to the collective tasks associated with provisioning and deployment of any suitable number of resources (e.g., infrastructure components, artifacts, etc.) corresponding to a single service.

A “service” refers to functionality provided by a set of resources. A set of resources for a service includes any suitable combination of infrastructure, platform, or software (e.g., an application) hosted by a cloud provider that can be configured to provide the functionality of a service. A service can be made available to users through the Internet.

An “artifact” refers to code being deployed to an infrastructure component (e.g., a physical or virtual host) or a Kubernetes engine cluster, this may include, but is not limited to, software (e.g., an application), configuration information (e.g., a configuration file) for an infrastructure component, or the like.

A “flock configuration file” or “flock config,” for brevity refers to a configuration file that describes a set of resources (e.g., infrastructure components and artifacts, also referred to as a “flock”) associated with a single service. A flock config may correspond to a single release (e.g., provisioning and/or deployment tasks that are to be performed as a unit). A flock config may correspond to an infrastructure release or an application release. A service may be built using any suitable number of releases and corresponding flock configs. A flock config may include declarative statements that specify one or more aspects corresponding to a desired state of the resources of the service for that release.

A “flock” refers to a set of CIOS managed resources or a set of execution targets that can be deployed as a unit. A flock may exist within an organizational unit referred to as a “project.”

“Service state” refers to a point-in-time snapshot of every resource (e.g., infrastructure resources, artifacts, etc.) associated with the service. The service state indicates status corresponding to provisioning and/or deployment tasks associated with service resources.

IaaS provisioning (or “provisioning”) refers to acquiring computers or virtual hosts for use, and even installing needed libraries or services on them. The phrase “provisioning a device” refers to evolving a device to a state in which it can be utilized by an end-user for their specific use. A device that has undergone the provisioning process may be referred to as a “provisioned device.” Preparing the provisioned device (installing libraries and daemons) may be part of provisioning; this preparation is different from deploying new applications or new versions of an application onto the prepared device. In most cases, deployment does not include provisioning, and the provisioning may need to be performed first. Once prepared, the device may be referred to as “an infrastructure component.”

IaaS deployment (or “deployment”) refers to the process of providing and/or installing a new application, or a new version of an application, onto a provisioned infrastructure component. Once the infrastructure component has been provisioned (e.g., acquired, assigned, prepared, etc.), additional software may be deployed (e.g., provided to and installed on the infrastructure component). The infrastructure component can be referred to as a “resource” after provisioning and deployment has concluded. Examples of resources may include, but are not limited to, virtual machines, databases, object storage, block storage, load balancers, and the like.

A “virtual bootstrap environment” (ViBE) refers to a virtual cloud network that is provisioned in the overlay of an existing region (e.g., a “host region”). Once provisioned, a ViBE is connected to a new region using a communication channel (e.g., an IPsec Tunnel VPN). Certain essential core services (or “seed” services) like a deployment orchestrator, a public key infrastructure (PKI) service, and the like can be provisioned in a ViBE. These services can provide the capabilities required to bring the hardware online, establish a chain of trust to the new region, and deploy the remaining services in the new region. Utilizing the virtual bootstrap environment can prevent circular dependencies between bootstrapping resources by utilizing resources of the host region. Services can be staged and tested in the ViBE prior to the physical region (e.g., the target region) being available.

A “Cloud Infrastructure Orchestration Service” (CIOS) may refer to a system configured to manage provisioning and deployment operations for any suitable number of services as part of a region build.

A “host region” refers to a region that hosts a virtual bootstrap environment (ViBE). A host region may be used to bootstrap a ViBE.

A “target region” refers to a region under build.

A “capability” identifies is a resource used during region build that signals that another resource, service, or feature is available, or that an event has occurred. By way of example, a capability can be published indicating that a resource is available for authorization/authentication processing (e.g., a subset of the functionality to be provided by a service). As another example, a capability can be published indicating the full functionality of the service is available. Capabilities may be used to identify functionality on which a resource or service depends and/or functionality of a resource or service that is available for use. A capability may be associated with an alphanumeric identifier and may be used to indicate the capability is available or unavailable.

“Publishing a capability” refers to “publishing” as used in a “publisher-subscriber” computing design or otherwise providing an indication that a particular capability is available (or unavailable). The capabilities are “published” (e.g., collected by a Capabilities Service, provided to a Capabilities Service, pushed, pulled, etc.) to provide an indication that functionality of a resource/service is available or that an event has occurred. In some embodiments, capabilities may be published/transmitted via an event, a notification, a data transmission, a function call, an API call, or the like. An event (or other notification/data transmission/etc.) indicating availability of a particular capability can be broadcasted/addressed (e.g., published) to a Capabilities Service.

A “Capabilities Service” may be a service configured to monitor and maintain capabilities data that indicates which capabilities are current available in a region. A Capabilities Service may be provided within a Cloud Infrastructure Orchestration System and may be used to identify what capabilities, services, features have been made available in a region, or which events have occurred within the region. The described Capabilities Service may service as a central repository/authority of all capabilities that have been published in the region (e.g., during a region build).

An “Orchestrator” is intended to refer to a service or system that initiates tasks involved in bootstrapping one or more services during a region build. A Multi-Flock Orchestrator (MFO), an example of an orchestrator, may be a computing component (e.g., a service) configured to coordinate events between components of the CIOS to provision and deploy services to a target region (e.g., a new region). An orchestrator may track relevant events (e.g., indicated through capabilities and/or skills as described herein) for each service of the region build and takes actions in response to those events (e.g., based on determining upstream dependencies have been met for a given release/skill, etc.).

A “Real-time Regional Data Distributor” (RRDD) may be a service or system configured to manage region data. This region data can be injected into flock configs to dynamically create execution targets for new regions.

A “Telemetry Service” may be a service or system that is configured to manage/monitor time series data associated with one or more services/resources and trigger (e.g., publish, store, etc.) various alarms and/or corresponding alarm states based at least in part on analyzing the time series data.

A “Skills Service” (also referred to as “Puffin”) may be a service or system that is configured to store planned and/or actual dependency relationships between services, resources, or units of functionality (also referred to as “service functionality”). It should be appreciated that the unit of functionality may relate to functionality provided by a computing component other than a service.

A “skill” may represent a functional unit that a service exposes and offers to consumers (e.g., other services). This functional unit (also referred to as “service functionality”) can include all or a subset of the total functionality associated with a service. In some embodiments, skills may be scoped where access is controlled based on access and/or authorization policies and/or based on an association with a particular namespace. A skill may be provided in multiple versions in which one or more aspects of the skill differs from other versions, where each skill version represents a specific implementation of the skill. Each skill version may be identifiable using a unique skill identifier. Skills are intended to replace (some or all) capabilities and enable enhanced and more accurate progress tracking of a region build as well as improved root cause analysis functionality when errors or unexpected events occur in the build. In some embodiments, a skill may be associated with one or more previously defined capabilities to provide backward compatibility with previous capabilities-based region build implementations. A skill may be monitored for health and may be configured to maintain health data.

A “fleet” refers to a logical environment (e.g., preproduction, production, etc.) to which a skill can be scoped. By way of example, a skill associated with a production fleet may be separate from a skill of the same name utilized with a preproduction fleet. A “project” may be similarly utilized to scope skills. In some embodiments, a skill may be scoped/applied to a particular environment based at least in part on any suitable combination of attributes such as skillID, skillversionID, compartmentID, namespaceID, producerServiceID, skillName, fleet, project, or the like, that collectively identify a particular application of a skill.

A “service plan specification” or “service plan,” for brevity, refers to a specification for a build implementation of a service. A service plan may include any suitable combination of build milestones, execution units, and flock configurations. A service plan details specific releases that may be needed (or that are needed) to build a service and the order by which the releases are to be performed to build the service. A service plan may separate inter-service coordination and intra-service coordination. A service plan may specify the expected state of a service at any suitable point of a region build.

A “service manifest” or “manifest,” for brevity, identifies the versions for flock configs and artifacts that are to be used to build a service. A service manifest may include a collection of service manifest items, each service manifest item identifying a particular flock config or artifact that may be needed (or is needed) to build a service. In some embodiments, a service manifest item may be associated with a git commit hash of the flock and all version declarations for any artifact that is required in application releases for that service's build.

A “SPAM” (also referred to as a “service build description”) refers to a combination of a service plan and a manifest that collectively provide a deterministic specification of the process for building a service. In some embodiments, a SPAM details a combination and order of releases that may be needed (or is needed) to build the service. A manifest of the SPAM may define all resources to be used for the releases, while the service plan specifies an order of release execution based on capability dependencies. A SPAM may be used to track compliance of a region build. A SPAM details the releases that may be necessary (or are necessary) to build a service where each release may be associated with pre- and post-conditions. The preconditions may refer to capabilities that may (or in some instances, must) be present such that a release can be created that will result in the postconditions being satisfied. The post-conditions may be capabilities that should (or in some cases, must) be published as a consequence of the release succeeding. SPAMs may be created by service teams and are derived from YAML files they author. The SPAM may be delineated into discrete sections, including execution units which define transitions between well-defined points in the service's build, known as “build milestones.” A service may transition from one build milestone to the next by performing the releases defined by an execution unit. Execution units may specify the external dependencies (capabilities) that may be (or are) required to perform the releases defined within the unit. Build milestones may specify the capabilities published by the service that should (or in some cases, must) be made available once the service has reached that milestone. In some embodiments, that the capabilities specified by a build milestone include capabilities that are intended for consumption by other services.

A “SPAM set” refers to a collection on SPAMs that are mutually compatible and/or that are previously associated with one another. A SPAM set may be used to derive a version set with which a directed acyclic graph may be generated and used to drive operations for building a data center. In some embodiments, a SPAM set may be associated with a scope and/or a regional context.

A “build milestone” refers to an entity defined in a service plan that identifies a synchronization point between the service build (e.g., the process for building a particular service) and the rest of the data center build. Build milestones may be defined coarsely to limit their number and provide a high-level overview of the process for building a service. As a non-limiting example, a set of build milestones for a service may include “absent” (e.g., a default starting milestone), “service functionality X available,” “service available,” and “service build complete.”

An “execution unit” refers to another entity of a service plan. One or more execution units may describe the process for transitioning from one build milestone to the next via a directed acyclic graph of CIOS releases (e.g., infrastructure and/or application releases).

An “execution target checkpoint” or “ET checkpoint,” for brevity, refers to a defined point in the data center build of a given execution target. An ET checkpoint may be associated with certain preconditions (e.g., required capability dependencies) and postconditions (capability publications) that should have met upon reaching that ET checkpoint. In some embodiments, steps identified within an execution unit may reference ET checkpoint transitions that may map logically to expected CIOS releases (e.g., infrastructure or application releases).

A “region archetype” may represent an overall structure of a region (e.g., an ONSR region, a single-availability-domain-region, a first region in a realm) that could be used to impact a service's installation. In some embodiments, a service plan may reference dimensions of a region archetype to conditionally change the service plan definition.

A “version set” may be used to define all flock configuration file and artifact versions across all services in a specific regional context (e.g., given a specific region such as “region1” and a specific version set identifier such as “golden” or “break glass”). A version set may be composed of many version set items, each of which may specify a flock and the artifacts for that flock. These entities may identify the existence of SPAMs and SPAM sets. By way of example, in some embodiments, a version set may be associated with a corresponding SPAM set. Any suitable version set item may be associated with a SPAM from which it was derived and/or corresponding to a common service.

“Static flock analysis” refers to an execution of a static analysis of code (e.g., that identifies data center infrastructure components as objects using a declarative configuration language) to infer capability publications and/or dependencies. In some embodiments, a static flock analysis may be performed utilizing an infrastructure-as-code software tool (e.g., Terraform®). In some embodiments, this software tool may generate one or more data structures (e.g., directed acyclic graphs) that represent these dependencies/publications. Each node in the graph may correspond to a flock config and/or a release, with edges identifying capability publications and/or dependencies between releases.

In some examples, techniques for implementing a Cloud Infrastructure Orchestration Service (CIOS) are described herein. Such techniques, as described briefly above, can be configured to manage bootstrapping (e.g., provisioning and deploying software to) infrastructure components within a cloud environment (e.g., a region). In some instances, the CIOS can include computing components (e.g., a CIOS Central and a CIOS Regional) that may be configured to manage bootstrapping tasks (provisioning and deployment) for a given service and an Orchestrator (e.g., a multi-flock orchestrator) configured to initiate/manage region builds (e.g., bootstrapping operations corresponding to multiple services in a region/data center).

CIOS enables region/data center building and world-wide infrastructure provisioning and code deployment with minimal manual run-time effort from service teams (e.g., beyond an initial approval and/or physical transportation of hardware, in some instances). The high-level responsibilities of CIOS include, but are not limited to, coordinating region builds in an automated fashion with minimal human intervention, providing users with a view of the current state of resources managed by the CIOS (e.g., of a region, across regions, world-wide, etc.), and managing bootstrapping operations for bootstrapping resources within a region.

The CIOS may provide view reconciliation, where a view of a desired state (e.g., a desired configuration) of resources may be reconciled with a current/actual state (e.g., a current configuration) of the resources. In some instances, view reconciliation may include obtaining state data to identify what resources are actually running and their current configuration and/or state. Reconciliation can be performed at a variety of granularities, such as at a service level.

CIOS can perform plan generation, where differences between the desired and current state of the resources are identified. Part of plan generation can include identifying the operations that would need to be executed to bring the resources from the current state to the desired state. Once the user is satisfied with a plan, the plan can then be marked as approved or rejected. Thus, users can spend less time reasoning about the plan and the plans are more accurate because they are machine generated. Plans are almost too detailed for human consumption; however, CIOS can provide this data via a sophisticated user interface (UI).

In some examples, CIOS can handle execution of change management by automatically executing the approved plan. Once an execution plan has been created and approved, engineers may no longer need to participate in change management unless CIOS initiates roll-back. CIOS can handle rolling back to a previous service version by automatically generating a plan that returns the service to a previous (e.g., pre-release) state (e.g., when CIOS detects service health degradation while executing).

CIOS can measure service health by monitoring alarms and executing integration tests. CIOS can help teams quickly define roll-back behavior in the event of service degradation, which it can later execute automatically. CIOS can automatically generate and display plans and can track approval. CIOS can combine the functionality of provisioning and deployment in a single system that coordinates these tasks across a region build. CIOS can discover dependencies between execution tasks at every level (e.g., resource level, execution target level, phase level, service level, etc.) through a static analysis (e.g., including parsing and processing content) of one or more configuration files. Using these dependencies, CIOS can generate various data structures from these dependencies that can be used to drive task execution (e.g., tasks regarding provisioning of infrastructure resources and deployment of artifacts across the region).

FIG. 8 is a block diagram of an environment 800 in which a Cloud Infrastructure Orchestration System (CIOS) 802 in which a Cloud Infrastructure Orchestration System (CIOS may operate to dynamically bootstrap services in a region/data center, according to at least one embodiment. CIOS 802 can include, but is not limited to, the following components: Real-time Regional Data Distributor (RRDD) 804, Orchestrator 806, CIOS Central 808, CIOS Regional 810, Capabilities Service 812, Virtual Bootstrap Environment 816, Puffin Central 818, Puffin Regional 820, and Alarm Service(s) 822. Specific functionality provided by CIOS Central 808 and CIOS Regional 810 is described in more detail in U.S. application Ser. No. 17/016,754, entitled “Techniques for Deploying Infrastructure Resources with a Declarative Provisioning Tool,” the entire contents of which are incorporated in its entirety for all purposes. In some embodiments, any suitable combination of the components of CIOS 802 may be provided as a service. In some embodiments, some portion of CIOS 802 may be deployed to a region (e.g., a data center represented by host region 803). In some embodiments, CIOS 802 may include any suitable number of cloud services (not depicted in FIG. 8) discussed in further detail below with respect to FIGS. 9 and 10.

Real-time Regional Data Distributor (RRDD) 804 may be configured to maintain and provide region data that identifies realms, regions, execution targets, and availability domains. In some cases, the region data may be in any suitable form (e.g., JSON format, data objects/containers, XML, etc.). Region data maintained by RRDD 804 may include any suitable number of subsets of data which can individually be referenceable by a corresponding identifier. By way of example, an identifier “all_regions” can be associated with a data structure (e.g., a list, a structure, an object, etc.) that includes a metadata for all defined regions. As another example, an identifier such as “realms” can be associated with a data structure that identifies metadata for a number of realms and a set of regions corresponding to each realm. In general, the region data may maintain any suitable attribute of one or more realm(s), region(s), availability domains (ADs), execution target(s) (ETs), and the like, such as identifiers, DNS suffixes, states (e.g., a state of a region), and the like. The RRDD 804 may be configured to manage region state as part of the region data. A region state may include any suitable information indicating a state of bootstrapping within a region. By way of example, some example region states can include “initial,” “building,” “production,” “paused,” or “deprecated.” The “initial” state may indicate a region that has not yet been bootstrapped. A “building” state may indicate that bootstrapping of one or more flocks within the region has commenced. A “production” state may indicate that bootstrapping has been completed and the region is ready for validation. A “paused” state may indicate that CIOS Central 808 or CIOS Regional 810 has paused internal interactions with the regional stack, likely due to an operational issue. A “deprecated” state may indicate the region has been deprecated and is likely unavailable and/or will not be contacted again.

CIOS Central 808 is configured to provide any suitable number of user interfaces with which users (e.g., user 809) may interact with CIOS 802. By way of example, users can make changes to region data via a user interface provided by CIOS Central 808. CIOS Central 808 may additionally provide a variety of interfaces that enable users to: view changes made to flock configs and/or artifacts, generate and view plans, approve/reject plans, view status on plan execution (e.g., corresponding to tasks involving infrastructure provisioning, deployment, region build, and/or desired state of any suitable number of resources managed by CIOS 802. CIOS Central 808 may implement a control plane configured to manage any suitable number of CIOS Regional 810 instances. CIOS Central 808 can provide one or more user interfaces for presenting region data, enabling the user 809 to view and/or change region data. CIOS Central 808 can be configured to invoke the functionality of RRDD 804 via any suitable number of interfaces. Generally, CIOS Central 808 (also referred to as a “provisioning and deployment manager”) may be configured to manage region data, cither directly or indirectly (e.g., via RRDD 804). CIOS Central 808 may be configured to compile flock configs (and/or SPAMs) to inject region data as variables within the flock configs (and/or SPAMs). CIOS Central 808 may be instructed (e.g., by Orchestrator 806) to perform one or more releases (e.g., infrastructure or application releases) corresponding to flock configs.

Each instance of CIOS Regional 810 may correspond to a module configured to execute bootstrapping tasks that are associated with a single service of a region (e.g., a data center such as host region 803). CIOS Regional 810 can receive desired state data from CIOS Central 808. In some embodiments, desired state data may include a flock config that declares (e.g., via declarative statements) a desired state of resources associated with a service. CIOS Central 808 can maintain current state data indicating any suitable aspect of the current state of the resources associated with a service. In some embodiments, CIOS Regional 810 can identify, through a comparison of the desired state data and the current state data, that changes that may be (or are) needed to one or more resources. For example, CIOS Regional 810 can determine that one or more infrastructure components need to be provisioned, one or more artifacts deployed, or any suitable change that may be (or is) needed to the resources of the service to bring the state of those resources in line with the desired state. As CIOS Regional 810 performs bootstrapping operations, it may publish data indicating various capabilities of a resource as they become available. A “capability” identifies a unit of functionality associated with a service. The unit could be a portion, or all of the functionality to be provided by the service. By way of example, a capability can be published indicating that a resource is available for authorization/authentication processing (e.g., a subset of the functionality to be provided by the resource). As another example, a capability can be published indicating the full functionality of the service is available. Capabilities can be used to identify functionality on which a resource or service depends and/or functionality of a resource or service that is available for use. In some embodiments, CIOS Regional 810 may transmit data indicating a state transition of a skill. By way of example, in some embodiments, CIOS Regional 810 performs bootstrapping operations which result in publishing a skill (e.g., transmitting skill metadata including a skill state value indicating the skill is installed). The skill metadata may be transmitted to Puffin (e.g., Puffin Regional 820) and used to update the skill state of the corresponding skill.

Capabilities Service 812 is configured to maintain capabilities data that indicates 1) what capabilities of various services are currently available, 2) whether any resource/service is waiting on a particular capability, 3) what particular resources and/or services are waiting on a given capability, or any suitable combination of the above. Capabilities Service 812 may provide an interface with which capabilities data may be requested. Capabilities Service 812 may provide one or more interfaces (e.g., application programming interfaces) that enable it to transmit capabilities data to Orchestrator 806, CIOS Regional 810 (e.g., each instance of CIOS Regional 810), Puffin Regional 820, and/or Puffin Central 818. In some embodiments, Capabilities Service 812 may store capabilities data in a data store that is accessible to one or more components of CIOS 802. Orchestrator 806, CIOS Regional 810 (e.g., each instance of CIOS Regional 810), Puffin Regional 820, and/or Puffin Central 818, and/or any suitable component or module of CIOS Regional 810 may be configured to request capabilities data from Capabilities Service 812 or otherwise obtain capabilities data (e.g., from a data store configured to store capabilities data generated by the Capabilities Service 812). Although the Capabilities Service 812 is depicted as being a separate component of CIOS 802, it should be appreciated that, in some embodiments, the functionality provided by Capabilities Service 812 may be provided, in whole or in part, as part of the Skills Service via any suitable combination of Puffin Central 818 and Puffin Regional 820.

In some embodiments, each regional component such as CIOS Regional 810, Capabilities Service 812, Puffin Regional 820, and/or Virtual Bootstrap Environment 816 may be one of many regional components. Each regional component may be specific to a given region (e.g., as depicted in FIG. 8, Host Region 803). Therefore, another region may include similar, but separate, components that are specific to that region. In some embodiments, central components (e.g., Orchestrator 806, CIOS Central 808, RRDD 804, and Puffin Central 818) may include one or more components that are configured to manage build operations corresponding to one or more regions. By way of example only, a single orchestrator (Orchestrator 806) may be utilized to manage bootstrapping operations for building any suitable number of data centers, or multiple instances of Orchestrator 806 may be utilized, each driving the bootstrapping operations for a subset of those data centers or a single data center.

In some embodiments, Orchestrator 806 (an example of which may be a multi-flock orchestrator, an orchestration service, etc.) may be configured to drive region build efforts. In some embodiments, Orchestrator 806 can manage information that describes which flock config versions and/or artifact versions are to be utilized to bootstrap a given service within a region (or to make a unit of change to a target region). In some embodiments, Orchestrator 806 may manage any suitable combination of flock configs and/or service plans. In some embodiments, Orchestrator 806 may be configured to monitor (or be otherwise notified of) changes to the region data managed by Real-time Regional Data Distributor 804. In some embodiments, receiving an indication that region data has been changed may cause a region build to be triggered by Orchestrator 806. In some embodiments, Orchestrator 806 may collect various flock configs, artifacts, and/or SPAMs to be used for a region build. Some, or all, of the flock configs and/or SPAMs may be configured to be region agnostic. That is, the flock configs and/or SPAMs may not explicitly identify what regions to which the flock is to be bootstrapped. In some embodiments, Orchestrator 806 may trigger a data injection process through which the collected flock configs and/or SPAMs are recompiled (e.g., by CIOS Central 808). During recompilation, operations may be executed (e.g., by CIOS Central 808) to cause the region data maintained by Real-time Regional Data Distributor 804 to be injected into the config files and/or SPAMs. Flock configs and/or SPAMs can reference region data through variables/parameters without requiring hard-coded identification of region data. The flock configs and/or SPAMs can be dynamically modified at run time using this data injection rather than having the region data be hardcoded, and therefore, and more difficult to change.

In some embodiments, Orchestrator 806 can perform a static flock analysis in which the flock configs and/or service plans are parsed to identify dependencies between resources, execution targets, execution target checkpoints, phases, and flocks, and in particular to identify circular dependencies that need to be removed. In some embodiments static flock analysis (SFA) data corresponding to this analysis may be stored (e.g., via DB 1012) for subsequent use. In some embodiments, Orchestrator 806 can generate any suitable number of data structures based on the dependencies identified. These data structures (e.g., directed acyclic graph(s), linked lists, etc.) may be utilized by CIOS 802 to drive operations for performing a region build. By way of example, these data structures may collectively define an order by which services are bootstrapped within a region. An example of such a data structure is discussed further below with respect to Build Dependency Graph 1038 of FIG. 10. If circular dependencies (e.g., service A requires service B and vice versa) exist and are identified through the static flock analysis and/or graph, Orchestrator 806 may be configured to notify any suitable service teams that changes are required to the corresponding flock config to correct these circular dependencies. Orchestrator 806 can be configured to traverse one or more data structures to manage an order by which services are bootstrapped to a region. Orchestrator 806 can identify (e.g., using data obtained from Capabilities Service 812) capabilities available within a given region at any given time. Orchestrator 806 may utilize this data to identify when it can bootstrap a service, when bootstrapping is blocked, and/or when bootstrapping operations associated with a previously blocked service can resume. Based on this traversal, Orchestrator 806 can perform a variety of releases in which instructions are transmitted by Orchestrator 806 to CIOS Central 808 to perform bootstrapping operations corresponding to any suitable number of flock configs. 1n some examples, Orchestrator 806 may be configured to identify that one or more flock configs may require multiple releases due to circular dependencies found within the graph. As a result, Orchestrator 806 may transmit multiple instruction sets to CIOS Central 808 for a given flock config to break the circular dependencies identified in the graph.

In some embodiments, one or service plan and manifests (SPAMs) may be utilized by the Orchestrator 806. A service plan and manifest may provide a deterministic specification of a build description for a service than previously provided by one or more flock configs. While flock configs specify aspects of a single release associated with a single service, a service plan may provide a single specification of the order and conditional requirements for executing all of the releases that may be needed (or are needed) to build a given service. Previous implementations of flock configs included optional dependencies which allowed for a degree of indeterministic behavior with respect to the order of operations performed during a region build. The inclusion of optional dependencies may require the Orchestrator 806 to perform multiple passes of the build dependency graph, resulting in wasteful processing. These types of dependencies make it difficult, if not impossible, for the system to track region build progress, identify remaining operations yet to be performed, and/or identify build completion. Service plans and manifests (SPAMs) may be utilized to eliminate at least some of the drawbacks to previous indeterministic approaches.

SPAMs (one SPAM corresponding to one service to be bootstrapped in the region) allow service teams to describe the corresponding operations that may be needed (or are needed) to build their service and may allow for separation between internal coordination (e.g., coordination of operations internal to the service) and external coordination (e.g., coordination of operations between components of different services). A number of visualizations may be provided (e.g., via Orchestrator 806 or any suitable component of CIOS 802) via one or more user interfaces. One visualization may depict a directed acyclic graph describing the build operations internal to a given service, and a separate visualization may depict a directed acyclic graph describing the order of build operations corresponding to multiple services (e.g., all services of the region/data center). As a specific example, one or more visualization can present a region-level directed acyclic graph (DAG) including only external coordination (e.g., an order of operations corresponding to coordination between services) while omitting operations that are internal with respect to each service. This DAG, for example, may depict nodes corresponding to one service's capabilities (or skills) on which other services depend, while excluding nodes corresponding to capability (or skill) dependencies between service components/functional units of the same service.

A SPAM may include an external interaction interface that includes a service build definition that includes a number of build milestones. Each build milestone may be associated with a set of capabilities (and/or skills) that the service is expected to publish upon reaching a given milestone. To transition between build milestones, the SPAM may include execution units that encapsulate a directed acyclic graph (DAG) of one or more releases, each release being equivalent to operations previously defined with a single flock config. Each execution unit may define a set of build time dependencies that identify one or more capabilities (and/or skills) that are required by at least one of the releases of the execution unit.

A SPAM may include a service build implementation. An execution unit of the SPAM may describe one or more releases that may be needed (or are needed) to build a service, with potentially multiple execution units being defined. Each execution unit may be associated with one or more execution target checkpoint transitions, each of which may be used to specify the expected capabilities that should be available before the time of the release and the capabilities that should be published as the result of performing the release.

In some embodiments, the Orchestrator 806 may be configured to aggregate SPAMs corresponding to each service to be deployed in a region to generate a larger directed acyclic graph (e.g., the Build Dependency Graph 1038 of FIG. 10) which may capture all of the operations necessary to build a region/data center. The collection of SPAMs identified from this aggregation may be referred to as a “SPAM set.” In some embodiments, the Orchestrator 806 may utilize the DAG generated from a SPAM set to validate a DAG and/or operations performed using flock configs, while the DAG generated from flock configs is used to drive build operations/release execution. Alternatively, the Orchestrator 806 may utilize the DAG generated from the SPAM set to drive build operations/release execution. The utilization of a SPAM/SPAM set may be utilized by the system to generate a deterministic execution plan with which the region build may be executed.

In some embodiments, Puffin Central 818 may provide a number of user interfaces with which one or more skills can be defined. A skill may be used with, or in lieu of, previously capabilities and enables improvements over previous capabilities-based implementations. In contrast with capabilities, skills may be scoped (e.g., controllable through access and authorization policies), versioned, and attributed to a particular service and/or contact. Skills may be associated with a lifecycle and may be monitored for health and are designed to be more highly visible/accessible than capabilities. Puffin Central 818 may provide an authoritative registry for skills. Various user interfaces managed by Puffin Central 818 may be utilized to define, maintain, and manage skills that each service offers, as well as their dependency relationships with other services. Puffin Central 818 may be utilized to declare and persist strongly defined metadata of services in a versioned manner. This metadata may be used to generate a blueprint for build-time and run-time dependencies. These blueprints can be used to validate build plans, to drive orchestration decisions during region build, and to improve time-to-engage and time-to-diagnose measures during region build and/or Large-Scale Events (LSEs).

Puffin Central 818 may be configured to serve as a source of truth for services and may maintain metadata including each service's upstream and downstream dependencies and service team contact information and methods for each service across regions and realms (e.g., a set of regions). Each skill may represent a function unit that a service exposes and offers to consumers (e.g., other services). In some embodiments, skills may be scoped where access is controlled based on access and/or authorization policies and/or based on an association with a particular namespace. A skill may be associated with multiple versions in which one or more aspects of the skill differs from previous versions, where each skill version represents a specific implementation of the skill. Each skill version may be identifiable using a unique skill identifier. In some embodiments, Puffin Central 818 may be configured to generate a skill corresponding to a previously defined capability in order to provide backward compatibility with previous capabilities-based region build implementations.

In some embodiments, Puffin may maintain compatibility between skills and capabilities, such that any suitable combination of the two may be utilized to define a process by which a service is to be built. Based on maintaining a mapping between skills and/or capabilities a service publishes, Puffin may ensure that a skill may be transitioned based on capabilities and/or a capability may be published due to a state change of a corresponding skill. In some embodiments, Puffin may generate “shadow skills” (e.g., system-generated skills that represent corresponding capabilities) and/or shadow capabilities (e.g., system-generated capabilities that publish when a corresponding skill is transitioned to an installed state). These features, provided by Puffin, enable the orchestrator to use any suitable combination of skills and/or capabilities to drive orchestration during a region build (e.g., during a process for building a data center).

In some embodiments, a skill may be mapped to one or more capabilities. Puffin Regional 820 may be configured to publish and/or store skills metadata based on capabilities data published (or stored) by the Capabilities Service 812. In some embodiments, Puffin Regional 820 may publish capabilities data to the Capabilities Service 812 and/or store such data based at least in part on publishing a skill or identifying a skill has transitioned to or is otherwise associated with a particular state. In some embodiments, some services may utilize flock configurations that express progress using capabilities, while other services may utilize a service plan and manifest that defines a deterministic build process in which progress is expressed with capabilities and/or skills. Using the mapping (or multiple mappings) between skills and capabilities, Puffin Regional 820 may enable a region build to be performed using any suitable combination of capabilities and/or skills to indicate that 1) service or resource functionality is available, 2) a particular event has transpired, 3) a particular fact is true, 4) a condition has been met, or any suitable combination of the above. This mapping or mappings enable CIOS 802 to perform a region build/data center build using any suitable combination of capabilities and/or skills, enabling service teams to transition from capabilities-based implementations to skills-based implementations gradually.

In some embodiments, any suitable computing component of the Puffin Service (e.g., Puffin Central 818 and/or Puffin Regional 820) may be configured to monitor the health and/or lifecycle of a skill according to a predefined skill lifecycle. Health monitoring may be performed using one or more alarms that are associated with a given skill. In some embodiments, a telemetry service (e.g., an example of alarm service(s) 822) may utilize an application programming interface provided by the Puffin Service (including Puffin Central 818 and/or Puffin Regional 820) when an alarm is triggered. As another example, the Puffin Service (e.g., Puffin Regional 820) may request alarm data from the alarm service(s) 822 and/or from storage locations at which the alarm service(s) 822 store the alarm data. The Puffin Service may present, via one or more user interfaces, information related to the health of a skill based on the alarms corresponding to the alarm data obtained and their corresponding association to a given skill.

In some embodiments, the Puffin Service (e.g., Puffin Central 818 and/or Puffin Regional 820) may expose one or more application programming interfaces (APIs) with which validation operations may be performed. By way of example, a SPAM describing the build process with respect to one or more services may be provided via a given API (e.g., by the Orchestrator 806). The Puffin Service (e.g., Puffin Central 818) may execute any suitable operations for validating that all services and skills identified in the SPAM have been previously registered with the Puffin Service and that the build process defined in the SPAM does not violate previously defined dependency relationships maintained by the Puffin Service. Additionally, or alternatively, Orchestrator 806 may perform any suitable validation check such as determining whether each flock config and/or artifact identified in a given service's manifest is referenced within the service's corresponding service plan and/or that no flock config and/or artifact is referenced within the service plan that is not referenced within the manifest. Orchestrator 806 may perform validation operations (e.g., a static analysis including parsing the service plan) to determine that a service plan lacks circular dependencies. If a circular dependency is found within a service plan, Orchestrator 806 may provide a notification and/or restrict the service plan and corresponding manifest from being utilized. In some embodiments, such restrictions may include restricting the service plan and manifest from being added to a SPAM set (e.g., a set of SPAMs to be used to perform a region build). In some embodiments, the Orchestrator 806 may perform any suitable validation operations to ensure that SPAMs of a SPAM set and/or a SPAM that is being considered as an addition to a preexisting SPAM set are mutually compatible. This may include analyzing the SPAM set (alone or with a SPAM that is being considered for addition) to ensure that the SPAMs of the SPAM set do not include circular dependencies.

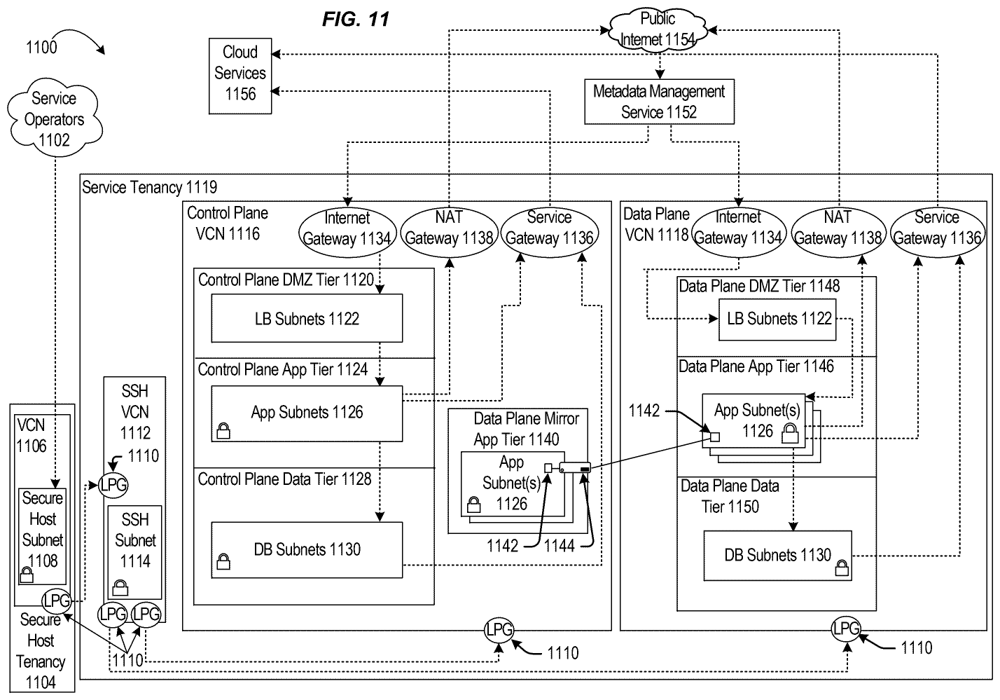

In some embodiments, a user can request that a new region (e.g., target region 814) be built. This can involve bootstrapping resources corresponding to a variety of services. In some embodiments, target region 814 may not be communicatively available (and/or secure) at a time at which the region build request is initiated. Rather than delay bootstrapping until such time as target region 814 is available and configured to perform bootstrapping operations, CIOS 802 may initiate the region build using a virtual bootstrap environment (e.g., Virtual Bootstrap Environment (ViBE) 816. ViBE 816 may be an overlay network that is hosted by host region 803 (a preexisting region that has previously been configured with a core set of services and which is communicatively available and secure). Orchestrator 806 can leverage resources of the host region 803 to bootstrap resources to the VIBE 816 (generally referred to as “building the ViBE”). By way of example, Orchestrator 806 can provide instructions through CIOS Central 808 that cause an instance of CIOS Regional 810 within a host region (e.g., host region 803) to bootstrap another instance of CIOS Regional within the VIBE 816. Once the CIOS Regional within the ViBE is available for processing, bootstrapping the services for the target region 814 can continue within the VIBE 816. When target region 814 is available to perform bootstrapping operations, the previously bootstrapped services within ViBE 816 may be migrated to target region 814. Utilizing these techniques, CIOS 802 can greatly improve the speed at which a region is built by drastically reducing the need for any manual input and/or configuration to be provided. In some embodiments, any suitable combination of the components depicted as part of CIOS 802 may individually be examples of the cloud services of FIGS. 11-11 (e.g., 1156 of FIG. 11) and may be configured to operate in any suitable infrastructure pattern such as the examples described below in connection with FIGS. 11-14.

FIG. 9 is a block diagram for illustrating an environment and method 900 for building a virtual bootstrap environment (ViBE) 902 (an example of ViBE 116 of FIG. 1), according to at least one embodiment. ViBE 902 represents a virtual cloud network that is provisioned in the overlay of an existing region (e.g., host region 904, an example of the host region 103 of FIG. 1 and in an embodiment is a Host Region Service Enclave). ViBE 902 represents an environment in which services can be staged for a target region (e.g., a region under build such as target region 114 of FIG. 1) before the target region becomes available.

In order to bootstrap a new region (e.g., target region 114 of FIG. 1), a core set of services may be bootstrapped. While those core set of services exist in the host region 904, they do not yet exist in the ViBE (nor the target region). These essential core services provide the functionality needed to provision devices, establish a chain of trust to the new region, and deploy remaining services into a region. The VIBE 902 may be a tenancy that is deployed in a host region 904 and used as a virtual region.

When the target region is available to provide bootstrapping operations, the VIBE 902 can be connected to the target region so that services in the ViBE can interact with the services and/or infrastructure components of the target region. This will enable deployment of production level services, instead of self-contained seed services as in previous systems, and may be connected over the internet to the target region. Conventionally, a seed service was deployed as part of a container collection and used to bootstrap dependencies necessary to build out the region. Using infrastructure/tooling of an existing region, resources may be bootstrapped (e.g., provisioned and deployed) into the VIBE 902 and connected to the service enclave of a region (e.g., host region 904) in order to provision (reserve and/or configure) hardware and deploy services until the target region is self-sufficient and can be communicated with directly. Utilizing the ViBE 902 allows for meeting the dependencies and providing the services needed to be able to provision/prepare infrastructure and deploy software while making use of the host region's resources in order to break circular dependencies of core services.

Orchestrator 906 (an example of Orchestrator 806 of FIG. 8) may be configured to perform operations to build (e.g., configure) ViBE 902. Orchestrator 906 can obtain applicable flock configs and/or SPAMs corresponding to various resources to be bootstrapped to the new region (in this case, a ViBE region, ViBE 902). By way of example, Orchestrator 906 may obtain a flock config (e.g., a “ViBE flock config”) that identifies aspects of bootstrapping Capabilities Service 908 (e.g., an example of Capabilities Service 812) and/or Worker 910. In some embodiments, Orchestrator 906 may additionally obtain a flock configuration identifying aspects of bootstrapping any suitable portion of a skills service (e.g., Puffin Regional 820 of FIG. 8). In some embodiments, one or more service plan and manifests (SPAMs) may be used to identify these aspects (e.g., specifying operations previously defined in one or more flock configuration files and/or the resources/artifacts that may be needed (or are needed) to bootstrap a service from start to finish) for bootstrapping any suitable combination of Capabilities Service 908, Worker 910, and/or Puffin Regional 909. As another example, Orchestrator 906 may obtain another flock config and/or SPAM corresponding to bootstrapping Domain Name Service (DNS) 912 to ViBE 902.

The method 900 may begin at step 1, where Orchestrator 906 may instruct CIOS Central 914 (e.g., an example of CIOS Central 808 and CIOS Central 914 of FIGS. 8 and 9, respectively). For example, Orchestrator 906 may transmit a request (e.g., including the VIBE flock config, which may be one flock config identified in a service plan) to request bootstrapping of the Capabilities Service 908 and Worker 910 (and in some embodiments, Puffin Regional 909) that, at this time do not yet exist in the VIBE 902. In some embodiments, a corresponding SPAM for the Capabilities Service 908, Worker 910, and/or Puffin Regional 909 may be utilized in lieu of or in addition to the ViBE flock config. In some embodiments, CIOS Central 914 may have access to all flock configs and/or SPAMs. Therefore, in some examples, Orchestrator 906 may transmit an identifier for the ViBE flock config and CIOS Central 914 may independently obtain the ViBE flock config from storage (e.g., from database (DB) 1008 or DB 1012 of FIG. 10).

At step 2, CIOS Central 914 may provide the ViBE flock config via a corresponding request to CIOS Regional 916. CIOS Regional 916 may parse the ViBE flock config to identify and execute specific infrastructure provisioning and deployment operations at step 3.

In some embodiments, the CIOS Regional 916 may utilize additional corresponding services for provisioning and deployment. For example, at step 4, CIOS Regional 916 CIOS Regional may instruct deployment orchestrator 918 (e.g., an example of a core service, or other write, build, and deploy applications software, of the host region 904) to execute instructions that in turn cause Capabilities Service 908, Worker 910, and in some embodiments Puffin Regional 909, to be bootstrapped within ViBE 902.

At step 5, capabilities data may be transmitted to the Capabilities Service 908 (from the CIOS Regional 916, Deployment Orchestrator 918 via the Worker 910 or otherwise) indicating that resources corresponding to the ViBE flock are available. Capabilities Service 908 may persist this data. In some embodiments, the Capabilities Service 908 adds this information to a list it maintains of available capabilities with the VIBE. By way of example, the capability provided to Capabilities Service 908 at step 5 may indicate the Capabilities Service 908 and Worker 910 (and in some embodiments, Puffin Regional 909) are available for processing. In some embodiments, skills metadata may be transmitted to Puffin Regional 909 indicating that any suitable combination of functionality corresponding to the Capabilities Service 908, Worker 910, and/or Puffin Regional 909 is available.

At step 6, Orchestrator 906 may identify that the Capabilities Service 908, Worker 910, and/or Puffin Regional 909 are available based on receiving or obtaining data (an identifier corresponding to a capability and/or skill) from the Capabilities Service 908 and/or Puffin Regional 909.

In some embodiments, published capabilities may be processed by Puffin Regional 909 (e.g., Puffin Regional 820 of FIG. 8) prior to processing by Orchestrator 906. In some embodiments, Puffin Regional 909 may be configured to provide forward and backward compatibility between skills and capabilities. By way of example, in some embodiments, if a capability is published to Puffin Regional 909, Puffin Regional 909 may query known skills (e.g., via a skills table or other suitable record of registered/previously generated skills) to check if any skill is associated with the capability. If no skill is associated with the capability, Puffin Regional 909 may be configured to create a skill (referred to as a “shadow skill) to represent the capability using the skill construct. When orchestrator 906 publishes skills (or updates skill state) during the process of performing a region build, Puffin Regional 909 may receive this data and identify one or more capabilities that are associated with the corresponding skill(s). Puffin Regional 909 may publish any or all capabilities associated with the skill that have not yet been published. In some embodiments, publishing such data may include storing an indication that these capabilities are available. In this manner, Puffin Regional 909 may support full compatibility between capabilities and skills such that any suitable combination of the two may be utilized to drive the operations performed during a region build.

Although some embodiments describe shadow skill generation being conducted at build time, it should be appreciated that the Puffin Service may generate shadow skills at any suitable time and according of a variety of methods. By way of example, historical capabilities data (e.g., capabilities data historically published during one or more previous region builds) may be obtained by the Puffin Service (e.g., Puffin Central 818 and/or Puffin Regional 820 of FIG. 8, and/or Puffin Regional 909 of FIG. 9, etc.) at any suitable time (e.g., prior to initiation of a region build, prior to deployment within the region, upon completion of region build, etc.). In some embodiments, the historical capabilities data may be stored (e.g., by an instance of Capabilities Service 812 of FIG. 8) in a data store that is accessible the Puffin Service. The Puffin Service may process the historical capabilities data (e.g., one or more files, records, tables, data structures, etc.) to identify one or more capabilities for which no corresponding skill currently exists. Identifying a corresponding skill may include matching any suitable portion of a tag or label of a capability with any suitable attribute and/or portion of an attribute (e.g., one or more tokens/words of a service name and/or identifier) associated with a service. A shadow skill may be generated by the Puffin Service for each historically published capability that fails to match any known skills. As described above, these shadow skills may be configured to represent a corresponding historically published capability and may be used to maintain compatibility between skills and capabilities, and between skill-based service build definitions (e.g., a SPAM) and capability-based service build definitions (e.g., a flock, a SPAM, etc.).

At step 7, as a result of receiving/obtaining the data at step 6, the Orchestrator 906 may instruct CIOS Central 914 to bootstrap a DNS service (e.g., DNS 912) to the ViBE 902. The instructions may identify or include a particular flock config and/or SPAM corresponding to the DNS service.

At step 8, the CIOS Central 914 may instruct the CIOS Regional 916 to deploy DNS 912 to the ViBE 902. In some embodiments, the DNS flock config and/or SPAM for the DNS 912 may be provided by the CIOS Central 914.

At step 9, Worker 910, now that it is deployed in the VIBE 902, may be assigned by CIOS Regional 916 to the task of deploying DNS 912. Worker may execute a declarative infrastructure provisioner in the manner described above in connection with FIG. 10 to identify a set of operations that are needed to deploy DNS 912. These operations may be identified based at least in part on from comparing the flock config (the desired state), or corresponding portion of a SPAM, to a current state of the (currently non-existing) resources associated with DNS 912.

At step 10, the Deployment Orchestrator 918 may instruct Worker 910 to deploy DNS 912 in accordance with the operations identified at step 9. As depicted, Worker 910 proceeds with executing operations to deploy DNS 912 to ViBE 902 at step 11. At step 12, Worker 910 may notify Capabilities Service 908 (via a capability) or Puffin Regional 909 (directly, or via Capabilities Service 908 and using a skill) that DNS 912 is available in ViBE 902. Orchestrator 906 may subsequently identify that the resources associated with the ViBE flock config and the DNS flock config are available any may proceed to bootstrap any suitable number of additional resources to the VIBE.

After steps 1-12 are concluded, the process for building the VIBE 902 may be considered complete and the VIBE 902 may be considered built and ready for additional bootstrapping (e.g., the bootstrapping of various cloud services such as cloud services 1156 of FIG. 11). At any suitable time during steps 1-12, Puffin Regional 909 may receive and/or obtain alarm data from one or more alarm services (e.g., the alarm service(s) 822 of FIG. 8). In some embodiments, the alarm data may be processed by Puffin Regional 909 (or Puffin Regional 909 may communicate the alarm data or data derived from the alarm data to Puffin Central 818 of FIG. 8). In some embodiments, Puffin Regional 909 (and/or Puffin Central 818) may communicate skill health information to Orchestrator 906 indicating corresponding health states associated with one or more skills. In some embodiments, Puffin Regional 909, Puffin Central 818, and/or Orchestrator 906 may be configured to execute operations that may pause (partially or fully) any suitable portion of the operations discussed above in connection with the method 900. In some embodiments, this may cause a regions state associated with the region within which method 900 is executed, to be updated to a state that indicates the build of the region is paused. In some embodiments, Puffin Regional 909, Puffin Central 818, and/or Orchestrator 906 may be configured to resume the operations of method 900 (and update the region state accordingly) based at least in part on user input, on subsequent alarm data indicating an update to a health state of one or more skills, on a skill health override value, or the like.

FIG. 10 is a block diagram for illustrating an environment and method 1000 for bootstrapping services to a target region utilizing the ViBE, according to at least one embodiment.

The method 1000 may begin at step 1, where user 1002 (e.g., a service team member) may interact with any suitable number of user interfaces managed by Puffin Central 1040 (e.g., Puffin Central 818 of FIG. 8). Puffin Central 1040 may be configured to read service and/or skill metadata from predefined files or the user 1002 may enter service metadata and/or skill metadata at one or more of the provided user interfaces. In some embodiments, Puffin Central 1040 may store all service and skill metadata and serve as a centralized authority for the same. At any suitable time, any suitable user may view the service and/or skill metadata such as prior to and/or during performance of the region build.

At step 2, user 1003 may utilize any suitable user interface provided by CIOS Central 1004 (an example of CIOS Central 808 and CIOS Central 914 of FIGS. 8 and 9, respectively) to modify region data. By way of example, user 1003 may create a new region to which a number of services are to be bootstrapped.

At step 3, CIOS Central 1004 may execute operations to send the change to RRDD 1006 (e.g., an example of RRDD 804 of FIG. 8). At step 4, RRDD 1006 may store the received region data in database 1008, a data store configured to store region data including any suitable identifier, attribute, state, etc. of a region, AD, realm, ET, or the like. In some embodiments, updater 1007 may be utilized to store region data in database 1008 or any suitable data store from which such updates may be accessible (e.g., to service teams). In some embodiments, updater 1007 may be configured to notify (e.g., via any suitable electronic notification) of updates made to database 1008.

At step 5, Orchestrator 1010 (an example of the Orchestrator 806 and/or 906 of FIGS. 8 and 9, respectively) may detect the change in region data. In some embodiments, Orchestrator 1010 may be configured to poll RRDD 1006 for changes in region data. In some embodiments, RRDD 1006 may be configured to publish or otherwise notify Orchestrator 1010 of region data changes.

At step 6, detecting the change in region data may trigger Orchestrator 1010 to obtain a version set (e.g., a version set associated with a particular identifier such as a “golden version set” identifier) identifying a particular version for each flock config and a particular version for each artifact to be used to build the region. The version set may be obtained from DB 1012. As flock configs and/or artifacts evolve and change over time, multiple versions of each may be maintained, and certain versions of each may be used for a region build. The version set may be persisted in DB 1012 such that Orchestrator 1010 may identify which versions of flock configs and artifacts to use for building a region (e.g., a ViBE region, a Target Region/non-ViBE Region, etc. The flock configs (e.g., all versions of the flock configs) and/or artifacts (e.g., all versions of the artifacts) may be stored in DB 1008, DB 1012, or any suitable data store accessible to the CIOS Central 1004 and/or Orchestrator 1010.

In some embodiments, Orchestrator 1010 may identify any suitable number of SPAMs (collectively referred to as a “SPAM set”) corresponding to the infrastructure to be provisioned and artifacts to be deployed as part of a region build. In some embodiments, each SPAM may identify versions corresponding to one or more flock configs and/or one or more artifacts that may be needed (or are needed) to build a single service. In embodiments in which one or more SPAMs are utilized, the SPAM(s) (or any suitable portion of the SPAM(s)) may be stored within DB 1012 and utilized to identify the particular flock config and/or artifact versions to be utilized for building the region. In some embodiments, the flock configs and/or artifact versions of a SPAM set may be included in the version set and stored within DB 1012. This enables some service teams to utilize a set of flock configs to define their service's build implementation while other service teams may choose to utilize a SPAM to define their service's build implementation.

In some embodiments, any suitable flock version sets and/or version set items may be derived from any suitable number of SPAMs and the Orchestrator 1010 may be configured to verify compliance of a flock's behavior (e.g., the build/orchestration operations identified within a flock config) complies with the process defined by a corresponding SPAM. The Orchestrator 1010 may be configured to ingest SPAMs which provide the information that may be required (or in some cases, that is required) to build an up-front plan of work and to introduce better guardrails than those available in previous implementations. Any suitable number of SPAMs may be aggregated into corresponding SPAM sets in a similar way that flocks may be aggregated into version sets. SPAM sets may enforce the invariant that all SPAMs within the set are mutually compatible and compose together to form a viable graph of releases required to build a region. In some embodiments, SPAM sets may be used within a given regional context to improve service build progress tracking. SPAM operations may be validated before they are applied and rejected if they are invalid, unlike version set item operations which were unconditionally applied. The utilization of SPAMs may enable the Orchestrator 1010 to build a deterministic plan of work prior to building a region, to block updates that would jeopardize or break an ongoing or future build, to improve the tracking of process of a service build, to detect deviations of flock behavior from the SPAM's specification, and to alert operators of deviations and status.

At step 7, Orchestrator 1010 may request CIOS Central 1004 to recompile each of the flock configs associated with the version set (including any suitable number of flock configs identified by a SPAM of a SPAM set) with the current region data. In some embodiments, the request may indicate a version for each flock config and/or artifact.

At step 8, CIOS Central 1004 may obtain current region data from the DB 1008 (e.g., directly, or via Real-time Regional Data Distributor 1006) and retrieve any suitable flock config and artifact in accordance with the versions requested by Orchestrator 1010.

At step 9, CIOS Central 1004 may recompile the obtained flock configs with the region data obtained at step 8 to inject those flock configs with current region data. CIOS Central 1004 may return the compiled flock configs to Orchestrator 1010. In some embodiments, CIOS Central 1004 may simply indicate compilation is done, and Orchestrator 1010 may access the recompiled flock configs via RRDD 1006.

In some embodiments, at step 10, Orchestrator 1010 may perform a static flock analysis of the recompiled flock configs (and/or SPAMs). As part of the static flock analysis, Orchestrator 1010 may parse the flock configs (and/or SPAMs) (e.g., using a library associated with a declarative infrastructure provisioner (e.g., Terraform®, or the like)) to identify dependencies. Data generated by the static flock analysis (e.g., “SFA data,” including the identified dependencies) may be stored for subsequent use. From the analysis and the dependencies identified (e.g., the SFA data), Orchestrator 1010 may generate any suitable number of data structures (e.g., directed acyclic graphs) that identify an order for releases identified in the flock configs (or from any suitable portion of one or more service plans, such as from a flock config entity of the service plan). A DAG that is generated based on a flock config (and/or any portion of a SPAM including, but not limited to flock config entity 800 of FIG. 8) and that specifies the releases and order of releases necessary to build a service may be referred to as a “service DAG.” In some embodiments, Orchestrator 1010 may generate a directed acyclic graph (referred to as a “build diagram”) corresponding to each SPAM in which each node represents a build milestone with edges indicating execution units and capabilities (and/or skills) that transition the service between build milestones. Each execution unit may represent a number of releases that, when performed, transition the service between build milestones. Any suitable number of service DAGs can be composed together to form Build Dependency Graph 1038. Build Dependency Graph 1038 may be an acyclic directed graph that identifies an order by which releases are to be executed to bootstrap one or more services within the new region.

In some embodiments, Build Dependency Graph 1038 may be a region-level dependency graph that includes every release that may be needed (or that is needed) for every service to be bootstrapped within the region/data center. Each node in the Build Dependency Graph 1038 may correspond to bootstrapping any suitable portion of a service. By way of example, each node of the Build Dependency Graph 1038 may correspond to a single release. The specific bootstrapping order (e.g., the order of release execution) may be identified based at least in part on the dependencies. In some embodiments, the dependencies may be expressed as an attribute of the node and/or indicated via edges of the graph that connect the nodes. Orchestrator 1010 may traverse the Build Dependency Graph 1038 (e.g., beginning at a starting node) to drive the operations of the region build. Any suitable portion of a service DAG and/or the Build Dependency Graph 1038 may be presented via one or more user interfaces (e.g., one or more interfaces provided by any suitable component of CIOS 802 of FIG. 8, including orchestrator 1010, CIOS Central 1004, or the like).

In some embodiments, Orchestrator 1010 may utilize a cycle detection algorithm to detect the presence of a cycle (e.g., service A depends on service B and vice versa). Orchestrator 1010 can identify orphaned capabilities dependencies. For example, Orchestrator 1010 can identify orphaned nodes of the Build Dependency Graph 1038 that do not connect to any other nodes. Orchestrator 1010 may identify falsely published capabilities (e.g., when a capability was prematurely published, and the corresponding functionality is not actually yet available). Orchestrator 1010 can detect from the graph that one or more instances of publishing the same capability exist. In some embodiments, any suitable number of these errors may be detected and Orchestrator 1010 (or another suitable component such as CIOS Central 1004) may be configured to notify or otherwise present this information to users (e.g., via an electronic notification, a user interface, or the like). In some embodiments, Orchestrator 1010 may be configured to force delete/recreate resources to break circular dependencies and may once again provide instructions to CIOS Central 1004 to perform bootstrapping operations for those resources and/or corresponding flock configs.

A starting node of the Build Dependency Graph 1038 may correspond to building the ViBE 1016 (or individual services within the ViBE), a second node may correspond to bootstrapping DNS. The steps 11-16 may correspond to deploying (via deployment orchestrator 1017, an example of the deployment orchestrator 918 of FIG. 9) the resources and/or artifacts identified in a corresponding VIBE flock config or SPAM to ViBE 1016 (e.g., an example of ViBE 816 and 902 of FIGS. 8, and 9, respectively). That is, steps 11-16 of FIG. 10 generally correspond to steps 1-6 of FIG. 9. Once notified that capabilities (or skills) exist (e.g., indicating that Capabilities Service 1018, Worker 1020, and/or Puffin Regional 1042, corresponding to Capabilities Service 908, Worker 910, and Puffin Regional 909 of FIG. 9, respectively, are deployed/available) the Orchestrator 1010 may recommence traversal of the Build Dependency Graph 1038 to identify which operations/releases to be executed next.

Orchestrator 1010 may continue traversing the Build Dependency Graph 1038 to identify that one or more releases corresponding to deploying DNS 1022 are to be executed. Steps 17-22 may be executed to deploy DNS 1022 (an example of the DNS 912 of FIG. 9). These operations may generally correspond to steps 7-12 of FIG. 9.

At step 22, a capability (or skill) may be published and/or stored indicating that DNS 1022 is available. In some embodiments, CIOS Regional 1014 and/or Deployment Orchestrator 1017 may initially communicate the availability of the capability or skill (e.g., to Capabilities Service 1018 or Puffin Regional 1042, respectively). If a skill is published, Puffin Regional 1042 may transmit data to Capabilities Service 1018 to indicate one or more corresponding capabilities are published. Upon detecting the publishing of a capability (e.g., via data provided by Capabilities Service 1018, perhaps triggered based on skill-related data provided by Puffin Regional 1042), Orchestrator 1010 may recommence traversal of the Build Dependency Graph 1038. On this traversal, the Orchestrator 1010 may identify that any suitable portion of an instance of CIOS Regional (e.g., an example of CIOS Regional 1014) is to be deployed to the ViBE 1016. In some embodiments, steps 17-22 may be substantially repeated with respect to deploying CIOS Regional (ViBE) 1026 (an instance of CIOS Regional 1014, CIOS Regional 810 of FIG. 8) and Worker 1028 to the ViBE 1016. A capability may be transmitted to the Capabilities Service 1018 that CIOS Regional (ViBE) 1026 is available. If a skill is used to indicate that CIOS Regional (ViBE) 1026 is available, Puffin Regional 1042 may transmit data to Capabilities Service 1018 indicating one or more corresponding capabilities are available. The interactions between Puffin Regional 1042 and Capabilities Service 1018 enable any suitable combination of capabilities and/or skills to be utilized to express progress through the region build. In some embodiments, when the Build Dependency Graph 1038 identifies transitions through capability publishing and dependencies, progress evidenced with skill publishing may be used to trigger corresponding capabilities publishing to enable skills to trigger progress of the region build.

Upon detecting the CIOS Regional (ViBE) 1026 is available, Orchestrator 1010 may recommence traversal of the Build Dependency Graph 1038. On this traversal, the Orchestrator 1010 may identify that a deployment orchestrator (e.g., Deployment Orchestrator 1030, an example of the Deployment Orchestrator 1017) is to be deployed to the VIBE 1016. In some embodiments, steps 16-21 may be substantially repeated with respect to deploying Deployment Orchestrator 1030. Information that identifies a capability may be transmitted to the Capabilities Service 1018 (e.g., by CIOS Regional 1014, worker 1020, and/or Puffin Regional 1042), indicating that Deployment Orchestrator 1030 is available.

After Deployment Orchestrator 1030 is deployed, ViBE 1016 may be considered available for processing subsequent requests. Upon detecting Deployment Orchestrator 1030 is available, Orchestrator 1010 may instruct subsequent bootstrapping requests to be routed to ViBE components rather than utilizing host region components (components of host region 1032). Thus, Orchestrator 1010 can continue traversing the Build Dependency Graph 1038, at each node instructing release execution to the VIBE 1016 via CIOS Central 1004. CIOS Central 1004 may transmit release requests CIOS Regional (ViBE) 1026 to effectuate release execution as instructed by Orchestrator 1010.

At any suitable point during this process, Target Region 1034 may become available. Indication that the Target Region is available may be identifiable from region data for the Target Region 1034 being provided by the user 1003 (e.g., as an update to the region data). The availability of Target Region 1034 may depend on establishing a network connection between the Target Region 1034 and external networks (e.g., the Internet). The network connection may be supported over a public network (e.g., the Internet), but use software security tools (e.g., IPSec) to provide one or more encrypted tunnels (e.g., IPSec tunnels such as tunnel 1036) from the VIBE 1016 to Target Region 1034. As used herein, “IPSec” refers to a protocol suite for authenticating and encrypting network traffic over a network that uses Internet Protocol (IP) and can include one or more available implementations of the protocol suite (e.g., Openswan, Libreswan, strongSwan, etc.). The network may connect the VIBE 1016 to the service enclave of the Target Region 1034.

Prior to establishing the IPSec tunnels, the initial network connection to the Target Region 1034 may be on a connection (e.g., an out-of-band VPN tunnel) sufficient to allow bootstrapping of networking services until an IPSec gateway may be deployed on an asset (e.g., bare-metal asset) in the Target Region 1034. To bootstrap the Target Region's network resources, Deployment Orchestrator 1030 can deploy the IPSec gateway at the asset within Target Region 1034. The Deployment Orchestrator 1030 may then deploy VPN hosts at the Target Region 1034 configured to terminate IPSec tunnels from the VIBE 1016. Once services (e.g., Deployment Orchestrator 1030, Service A, etc.) in the VIBE 1016 can establish an IPSec connection with the VPN hosts in the Target Region 1034, bootstrapping operations from the VIBE 1016 to the Target Region 1034 may begin.

In some embodiments, the bootstrapping operations may begin with services in the ViBE 1016 provisioning resources in the Target Region 1034 to support hosting instances of core services as they are deployed from the VIBE 1016. For example, a host provisioning service may provision hypervisors on infrastructure (e.g., bare-metal hosts) in the Target Region 1034 to allocate computing resources for VMs. When the host provisioning service completes allocation of physical resources in the Target Region 1034, the host provisioning service may publish information indicating a capability that indicates that the physical resources in the Target Region 1034 have been allocated. The capability may be published to Capabilities Service 1018 via CIOS Regional (ViBE) 1026 (e.g., by Worker 1028).

With the hardware allocation of the Target Region 1034 established and posted to Capabilities Service 1018, CIOS Regional (ViBE) 1026 can orchestrate the deployment of instances of core services from the VIBE 1016 to the Target Region 1034. This deployment may be similar to the processes described above for building the VIBE 1016, but using components of the ViBE (e.g., CIOS Regional (ViBE) 1026, Worker 1028, Deployment Orchestrator 1030) instead of components of the Host Region 1032 service enclave (e.g., CIOS Regional 1014 and Deployment Orchestrator 1017). The deployment operations may generally correspond to steps 17-22 described above.

As a service is deployed from the VIBE 1016 to the Target Region 1034, the DNS record associated with that service may correspond to the instance of the service in the ViBE 1016. The DNS record associated with the service may be updated at any suitable time to complete deployment of the service to the Target Region 1034. Said another way, the instance of the service in the ViBE 1016 may continue to receive traffic (e.g., requests) until the DNS record is updated. A service may deploy partially into the Target Region 1034 and publish information indicating a capability (e.g., to Capabilities Service 1018) that the service is partially deployed. For example, a service running in the VIBE 1016 may be deployed into the Target Region 1034 with a corresponding compute instance, load balancer, and associated applications and other software, but may need to wait for database data to migrate to the Target Region 1034 before being completely deployed. The DNS record (e.g., managed by DNS 1022) may still be associated with the service in the ViBE 1016. Once data migration for the service is complete, the DNS record may be updated to point to the operational service deployed in the Target Region 1034. The deployed service in the Target Region 1034 may then receive traffic (e.g., requests) for the service, while the instance of the service in the VIBE 1016 may no longer receive traffic for the service.

At any suitable time during method 1000, Puffin Regional 909 may receive and/or obtain alarm data from one or more alarm services (e.g., the alarm service(s) 1044, an example of the alarm service(s) 822 of FIG. 8). In some embodiments, the alarm data may be processed by Puffin Regional 1042 (or Puffin Regional 1042 may communicate the alarm data or data derived from the alarm data to Puffin Central 1040). In some embodiments, Puffin Regional 1042 and/or Puffin Central 1040 may communicate skill health information to Orchestrator 1010 indicating corresponding health states associated with one or more skills. In some embodiments, Puffin Regional 1042, Puffin Central 1040, and/or Orchestrator 1010 may be configured to execute operations that pause or otherwise halt any suitable portion of the operations discussed above in connection with the method 1000. In some embodiments, Puffin Regional 1042, Puffin Central 1040, and/or Orchestrator 1010 may be configured to resume and/or execute any suitable portion of the operations of method 1000 (e.g., based at least in part on user input, subsequent alarm data indicating an update to a health state associated with one or more skills, based at least in part on a skill health override value, or the like).

In some embodiments, the flocks and/or SPAMs discussed above in connection with FIGS. 8-10 may reference any suitable combination of a service image, an infrastructure release, or an application release. In some embodiments, a service image may be used to encapsulate any suitable number of infrastructure and/or application releases such that what would have been multiple nodes of build dependency graph 338 may be condensed into a single node that references the service image. Thus, service images may be used to reduce the size of the build dependency graph 338, which in turn may reduce the latency of building a region/data center.

### Example IaaS Environments

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 11 is a block diagram 1100 illustrating an example pattern of an IaaS architecture, according to at least one embodiment. Service operators 1102 can be communicatively coupled to a secure host tenancy 1104 that can include a virtual cloud network (VCN) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (LPG) 1110 that can be communicatively coupled to a secure shell (SSH) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (DMZ) tier 1120 that acts as a perimeter network (e.g., portions of a corporate network between the corporate intranet and external networks). The DMZ-based servers may have restricted responsibilities and help keep breaches contained. Additionally, the DMZ tier 1120 can include one or more load balancer (LB) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (API) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (CRUD) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Metadata that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of threat prevention, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

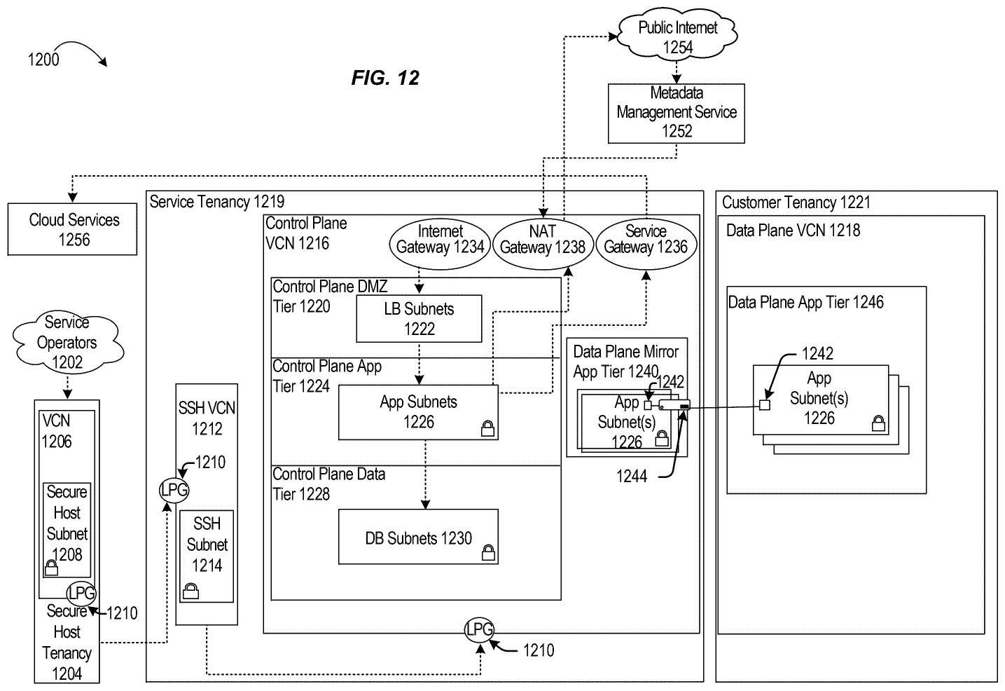

FIG. 12 is a block diagram 1200 illustrating another example pattern of an IaaS architecture, according to at least one embodiment. Service operators 1202 (e.g., service operators 1102 of FIG. 11) can be communicatively coupled to a secure host tenancy 1204 (e.g., the secure host tenancy 1104 of FIG. 11) that can include a virtual cloud network (VCN) 1206 (e.g., the VCN 1106 of FIG. 11) and a secure host subnet 1208 (e.g., the secure host subnet 1108 of FIG. 11). The VCN 1206 can include a local peering gateway (LPG) 1210 (e.g., the LPG 1110 of FIG. 11) that can be communicatively coupled to a secure shell (SSH) VCN 1212 (e.g., the SSH VCN 1112 of FIG. 11) via an LPG 1110 contained in the SSH VCN 1212. The SSH VCN 1212 can include an SSH subnet 1214 (e.g., the SSH subnet 1114 of FIG. 11), and the SSH VCN 1212 can be communicatively coupled to a control plane VCN 1216 (e.g., the control plane VCN 1116 of FIG. 11) via an LPG 1210 contained in the control plane VCN 1216. The control plane VCN 1216 can be contained in a service tenancy 1219 (e.g., the service tenancy 1119 of FIG. 11), and the data plane VCN 1218 (e.g., the data plane VCN 1118 of FIG. 11) can be contained in a customer tenancy 1221 that may be owned or operated by users, or customers, of the system.

The control plane VCN 1216 can include a control plane DMZ tier 1220 (e.g., the control plane DMZ tier 1120 of FIG. 11) that can include LB subnet(s) 1222 (e.g., LB subnet(s) 1122 of FIG. 11), a control plane app tier 1224 (e.g., the control plane app tier 1124 of FIG. 11) that can include app subnet(s) 1226 (e.g., app subnet(s) 1126 of FIG. 11), a control plane data tier 1228 (e.g., the control plane data tier 1128 of FIG. 11) that can include database (DB) subnet(s) 1230 (e.g., similar to DB subnet(s) 1130 of FIG. 11). The LB subnet(s) 1222 contained in the control plane DMZ tier 1220 can be communicatively coupled to the app subnet(s) 1226 contained in the control plane app tier 1224 and an Internet gateway 1234 (e.g., the Internet gateway 1134 of FIG. 11) that can be contained in the control plane VCN 1216, and the app subnet(s) 1226 can be communicatively coupled to the DB subnet(s) 1230 contained in the control plane data tier 1228 and a service gateway 1236 (e.g., the service gateway 1136 of FIG. 11) and a network address translation (NAT) gateway 1238 (e.g., the NAT gateway 1138 of FIG. 11). The control plane VCN 1216 can include the service gateway 1236 and the NAT gateway 1238.

The control plane VCN 1216 can include a data plane mirror app tier 1240 (e.g., the data plane mirror app tier 1140 of FIG. 11) that can include app subnet(s) 1226. The app subnet(s) 1226 contained in the data plane mirror app tier 1240 can include a virtual network interface controller (VNIC) 1242 (e.g., the VNIC of 1142) that can execute a compute instance 1244 (e.g., similar to the compute instance 1144 of FIG. 11). The compute instance 1244 can facilitate communication between the app subnet(s) 1226 of the data plane mirror app tier 1240 and the app subnet(s) 1226 that can be contained in a data plane app tier 1246 (e.g., the data plane app tier 1146 of FIG. 11) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g., the metadata management service 1152 of FIG. 11) that can be communicatively coupled to public Internet 1254 (e.g., public Internet 1154 of FIG. 11). Public Internet 1254 can be communicatively coupled to the NAT gateway 1238 contained in the control plane VCN 1216. The service gateway 1236 contained in the control plane VCN 1216 can be communicatively coupled to cloud services 1256 (e.g., cloud services 1156 of FIG. 11).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources, that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218 but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 11,” may be located in Region 1 and in “Region 2.” If a call to Deployment 11 is made by the service gateway 1236 contained in the control plane VCN 1216 located in Region 1, the call may be transmitted to Deployment 11 in Region 1. In this example, the control plane VCN 1216, or Deployment 11 in Region 1, may not be communicatively coupled to, or otherwise in communication with, Deployment 11 in Region 2.

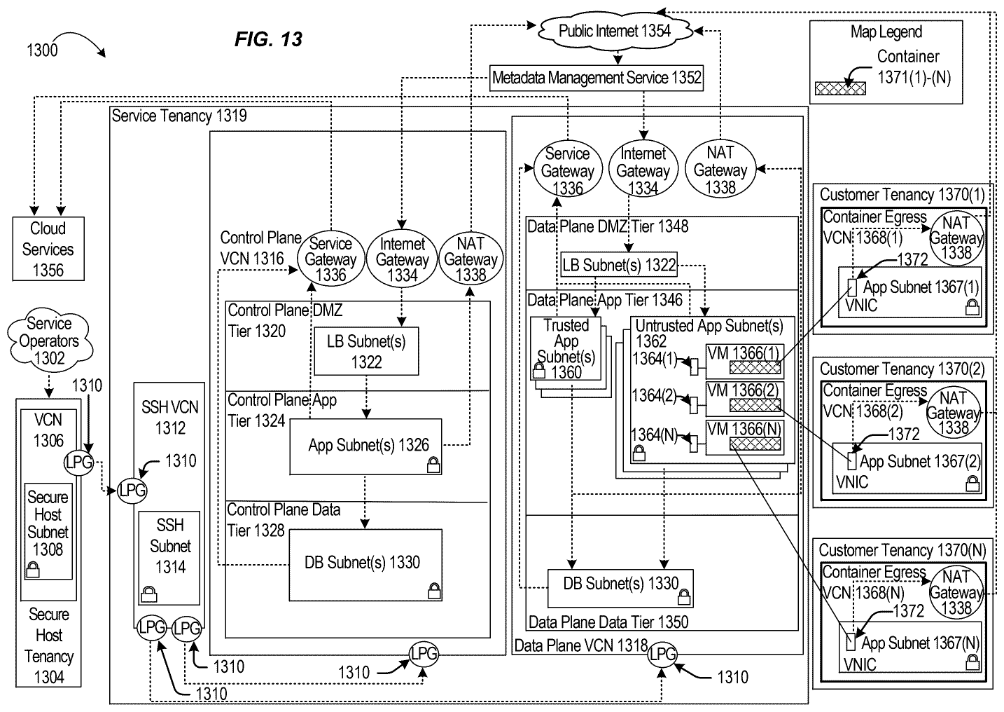

FIG. 13 is a block diagram 1300 illustrating another example pattern of an IaaS architecture, according to at least one embodiment. Service operators 1302 (e.g., service operators 1102 of FIG. 11) can be communicatively coupled to a secure host tenancy 1304 (e.g., the secure host tenancy 1104 of FIG. 11) that can include a virtual cloud network (VCN) 1306 (e.g., the VCN 1106 of FIG. 11) and a secure host subnet 1308 (e.g., the secure host subnet 1108 of FIG. 11). The VCN 1306 can include an LPG 1310 (e.g., the LPG 1110 of FIG. 11) that can be communicatively coupled to an SSH VCN 1312 (e.g., the SSH VCN 1112 of FIG. 11) via an LPG 1310 contained in the SSH VCN 1312. The SSH VCN 1312 can include an SSH subnet 1314 (e.g., the SSH subnet 1114 of FIG. 11), and the SSH VCN 1312 can be communicatively coupled to a control plane VCN 1316 (e.g., the control plane VCN 1116 of FIG. 11) via an LPG 1310 contained in the control plane VCN 1316 and to a data plane VCN 1318 (e.g., the data plane 1118 of FIG. 11) via an LPG 1310 contained in the data plane VCN 1318. The control plane VCN 1316 and the data plane VCN 1318 can be contained in a service tenancy 1319 (e.g., the service tenancy 1119 of FIG. 11).

The control plane VCN 1316 can include a control plane DMZ tier 1320 (e.g., the control plane DMZ tier 1120 of FIG. 11) that can include load balancer (LB) subnet(s) 1322 (e.g., LB subnet(s) 1122 of FIG. 11), a control plane app tier 1324 (e.g., the control plane app tier 1124 of FIG. 11) that can include app subnet(s) 1326 (e.g., similar to app subnet(s) 1126 of FIG. 11), a control plane data tier 1328 (e.g., the control plane data tier 1128 of FIG. 11) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134 of FIG. 11) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 11) and a network address translation (NAT) gateway 1338 (e.g., the NAT gateway 1138 of FIG. 11). The control plane VCN 1316 can include the service gateway 1336 and the NAT gateway 1338.

The data plane VCN 1318 can include a data plane app tier 1346 (e.g., the data plane app tier 1146 of FIG. 11), a data plane DMZ tier 1348 (e.g., the data plane DMZ tier 1148 of FIG. 11), and a data plane data tier 1350 (e.g., the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g., public Internet 1154 of FIG. 11).

The Internet gateway 1334 contained in the control plane VCN 1316 and contained in the data plane VCN 1318 can be communicatively coupled to a metadata management service 1352 (e.g., the metadata management system 1152 of FIG. 11) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

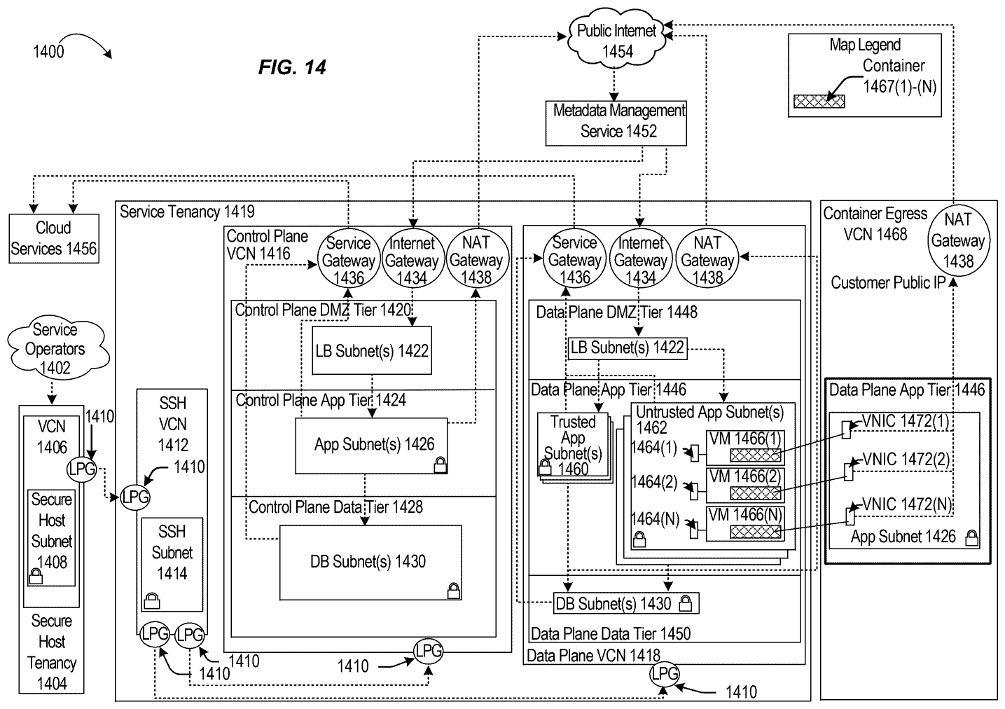

FIG. 14 is a block diagram 1400 illustrating another example pattern of an IaaS architecture, according to at least one embodiment. Service operators 1402 (e.g., service operators 1102 of FIG. 11) can be communicatively coupled to a secure host tenancy 1404 (e.g., the secure host tenancy 1104 of FIG. 11) that can include a virtual cloud network (VCN) 1406 (e.g., the VCN 1106 of FIG. 11) and a secure host subnet 1408 (e.g., the secure host subnet 1108 of FIG. 11). The VCN 1406 can include an LPG 1410 (e.g., the LPG 1110 of FIG. 11) that can be communicatively coupled to an SSH VCN 1412 (e.g., the SSH VCN 1112 of FIG. 11) via an LPG 1410 contained in the SSH VCN 1412. The SSH VCN 1412 can include an SSH subnet 1414 (e.g., the SSH subnet 1114 of FIG. 11), and the SSH VCN 1412 can be communicatively coupled to a control plane VCN 1416 (e.g., the control plane VCN 1116 of FIG. 11) via an LPG 1410 contained in the control plane VCN 1416 and to a data plane VCN 1418 (e.g., the data plane 1118 of FIG. 11) via an LPG 1410 contained in the data plane VCN 1418. The control plane VCN 1416 and the data plane VCN 1418 can be contained in a service tenancy 1419 (e.g., the service tenancy 1119 of FIG. 11).

The control plane VCN 1416 can include a control plane DMZ tier 1420 (e.g., the control plane DMZ tier 1120 of FIG. 11) that can include LB subnet(s) 1422 (e.g., LB subnet(s) 1122 of FIG. 11), a control plane app tier 1424 (e.g., the control plane app tier 1124 of FIG. 11) that can include app subnet(s) 1426 (e.g., app subnet(s) 1126 of FIG. 11), a control plane data tier 1428 (e.g., the control plane data tier 1128 of FIG. 11) that can include DB subnet(s) 1430 (e.g., DB subnet(s) 1330 of FIG. 13). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134 of FIG. 11) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 11) and a network address translation (NAT) gateway 1438 (e.g., the NAT gateway 1138 of FIG. 11). The control plane VCN 1416 can include the service gateway 1436 and the NAT gateway 1438.

The data plane VCN 1418 can include a data plane app tier 1446 (e.g., the data plane app tier 1146 of FIG. 11), a data plane DMZ tier 1448 (e.g., the data plane DMZ tier 1148 of FIG. 11), and a data plane data tier 1450 (e.g., the data plane data tier 1150 of FIG. 11). The data plane DMZ tier 1448 can include LB subnet(s) 1422 that can be communicatively coupled to trusted app subnet(s) 1460 (e.g., trusted app subnet(s) 1360 of FIG. 13) and untrusted app subnet(s) 1462 (e.g., untrusted app subnet(s) 1362 of FIG. 13) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N) and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g., public Internet 1154 of FIG. 11).

The Internet gateway 1434 contained in the control plane VCN 1416 and contained in the data plane VCN 1418 can be communicatively coupled to a metadata management service 1452 (e.g., the metadata management system 1152 of FIG. 11) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively coupled to cloud services 1456.

In some examples, the pattern illustrated by the architecture of block diagram 1400 of FIG. 14 may be considered an exception to the pattern illustrated by the architecture of block diagram 1300 of FIG. 13 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

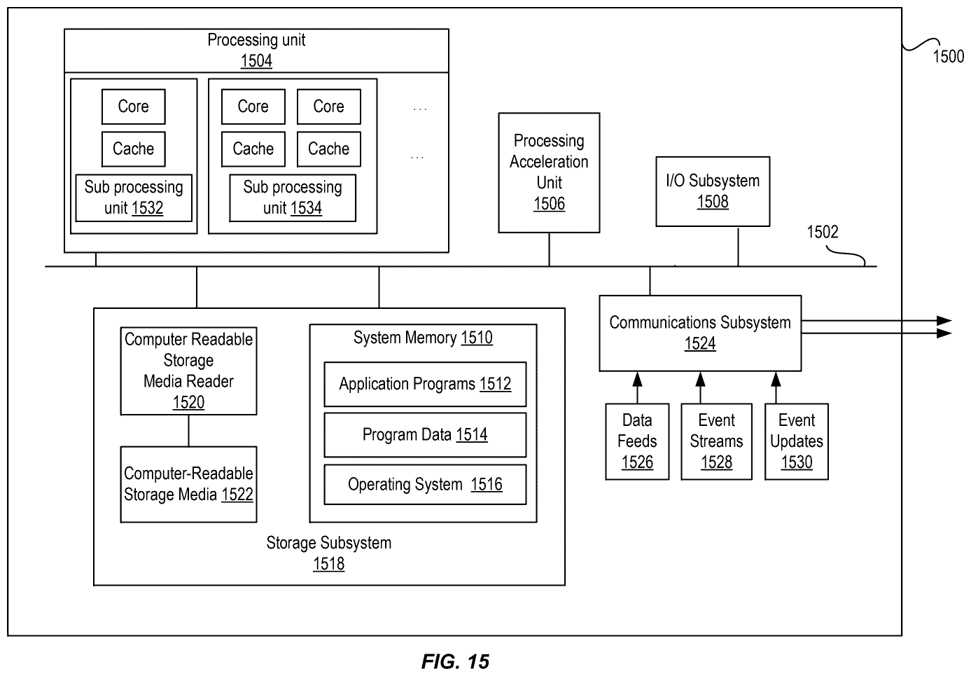

FIG. 15 illustrates an example computer system 1500, in which various embodiments may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1504 provide the functionality described above. Storage subsystem 1518 may also provide a repository for storing data used in accordance with the present disclosure.

As depicted in the example in FIG. 15, storage subsystem 1518 can include various components including a system memory 1510, computer-readable storage media 1522, and a computer readable storage media reader 1520. System memory 1510 may store program instructions that are loadable and executable by processing unit 1504. System memory 1510 may also store data that is used during the execution of the instructions and/or data that is generated during the execution of the program instructions. Various different kinds of programs may be loaded into system memory 1510 including but not limited to client applications, Web browsers, mid-tier applications, relational database management systems (RDBMS), virtual machines, containers, etc.

System memory 1510 may also store an operating system 1516. Examples of operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1500 executes one or more virtual machines, the virtual machines along with their guest operating systems (GOSs) may be loaded into system memory 1510 and executed by one or more processors or cores of processing unit 1504.

System memory 1510 can come in different configurations depending upon the type of computer system 1500. For example, system memory 1510 may be volatile memory (such as random-access memory (RAM)) and/or non-volatile memory (such as read-only memory (ROM), flash memory, etc.) Different types of RAM configurations may be provided including a static random-access memory (SRAM), a dynamic random-access memory (DRAM), and others. In some implementations, system memory 1510 may include a basic input/output system (BIOS) containing basic routines that help to transfer information between elements within computer system 1500, such as during start-up.

Computer-readable storage media 1522 may represent remote, local, fixed, and/or removable storage devices plus storage media for temporarily and/or more permanently containing, storing, computer-readable information for use by computer system 1500 including instructions executable by processing unit 1504 of computer system 1500.

Computer-readable storage media 1522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1500.

Machine-readable instructions executable by one or more processors or cores of processing unit 1504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

1. A computer-implemented method, comprising:
obtaining, by a computing system of a first cloud-computing environment, metadata corresponding to a first service resource of the first cloud-computing environment, the first service resource being one of a first plurality of service resources associated with a first service;
generating, by the computing system, modified metadata comprising a data object that replaces a parameter of the metadata, the parameter being replaced being identified according to a predefined parameterization specification;
obtaining, by the computing system, an image that was previously installed at the first service resource;
obtaining, by the computing system, runtime state data identifying a runtime state of the first service resource;
generating, by the computing system, a service image comprising serialized snapshot data corresponding to the first service resource, the service image comprising a plurality of data bytes generated from a combination of the image that was previously installed at the first service resource, the modified metadata comprising the data object that replaces the parameter of the metadata, and the runtime state data identifying the runtime state of the first service resource; and
storing, by the computing system, the service image comprising the serialized snapshot data corresponding to the first service resource, wherein the service image enables a second service resource to be provisioned and configured, within a second cloud-computing environment, to begin execution from a state corresponding to the runtime state of the first service resource of the first cloud-computing environment.

2. The computer-implemented method of claim 1, wherein the serialized snapshot data comprises at least one of a snapshot identifier, a compartment identifier corresponding to the first service resource, a stack identifier, an image identifier, or a network address.

3. The computer-implemented method of claim 1, wherein the metadata corresponding to the first service resource is obtained from a declarative provisioning and deployment system using an application programming interface.

4. (canceled)

5. (canceled)

6. The computer-implemented method of claim 1, further comprising
identifying, by the computing system, that the first service resource is associated with a storage resource type; and
in response to identifying that the first service resource is associated with the storage resource type, obtaining replicated data that replicates corresponding data stored at the first service resource, wherein the serialized snapshot data is generated to further comprise the replicated data.

7. The computer-implemented method of claim 1, further comprising
transmitting, by the computing system to a second computing system, a request identifying the serialized snapshot data, wherein transmitting the request causes the second computing system to configure the second cloud-computing environment with the first service resource according to the serialized snapshot data generated from the first service resource of the first cloud-computing environment and from the state corresponding to the runtime state of the first service resource.

8. A system, comprising:
one or more processors; and
one or more memories storing computer-executable instructions that, when executed by the one or more processors, cause the one or more processors to:
obtain metadata corresponding to a first service resource of a first cloud-computing environment, the first service resource being one of a first plurality of service resources associated with a first service;
generate modified metadata based at least in part on adding a data object to the metadata;
obtain runtime state data identifying a runtime state of the first service resource;
obtain an image associated with the first service resource;
generate a service image comprising the image, the modified metadata, and the runtime state data; and
store the service image corresponding to the first service resource, the service image defining a configuration and a corresponding runtime state with which a second service resource of a second cloud-computing environment is configurable.

9. The system of claim 8, wherein executing the computer-executable instructions further causes the one or more processors to transmit, to a computing component of the second cloud-computing environment, a manifest, the manifest comprising an identifier for the service image.

10. The system of claim 9, wherein the manifest is transmitted in a request comprising at least one of a compartment identifier, a stack identifier, an image identifier, or a network address.

11. The system of claim 10, wherein executing the computer-executable instructions that transmit the request causes a component of the second cloud-computing environment to obtain the service image and to configure the second service resource within the second cloud-computing environment.

12. The system of claim 8, wherein the first cloud-computing environment is a first compartment of a cloud-computing region, and wherein the second cloud-computing environment is a second compartment of the cloud-computing region.

13. The system of claim 8, wherein executing the computer-executable instructions that add the data object causes the one or more processors to replace a parameter of the metadata with the data object.

14. A non-transitory computer readable medium comprising one or more memories storing computer-executable instructions that, when executed by one or more processors, cause the one or more processors to:
obtain metadata corresponding to a first service resource of a first cloud-computing environment, the first service resource being one of a first plurality of service resources associated with a first service;
generate modified metadata based at least in part on adding a data object to the metadata;
obtain an image associated with the first service resource;
obtain runtime state data identifying a runtime state of the first service resource;
generate a service image comprising the image, the modified metadata, and the runtime state data; and
store the service image corresponding to the first service resource, the service image defining a configuration and a corresponding runtime state with which a second service resource of a second cloud-computing environment is configurable.

15. The non-transitory computer readable medium of claim 14, wherein the data object of the modified metadata represents data that may be overwritten in accordance with corresponding data values associated with the second cloud-computing environment.

16. (canceled)

17. (canceled)

18. (canceled)

19. The non-transitory computer readable medium of claim 14, wherein executing the computer-executable instructions to add the data object causes the one or more processors to replace a network address of the metadata with the data object.

20. The non-transitory computer readable medium of claim 19, wherein executing the computer-executable instructions further causes the one or more processors to obtain a volume snapshot corresponding to the first service resource, the volume snapshot corresponding to data stored at the first service resource, wherein the service image is generated to further comprise the volume snapshot corresponding to the first service resource.

21. The computer-implemented method of claim 1, wherein the first plurality of service resources comprises at least two of: a compute instance, a networking component, and a storage resource.

22. The computer-implemented method of claim 1, wherein the runtime state data identifies at least two of: content of a storage volume, one or more current network connections, one or more network security policies, or one or more running processes of the first service resource.

23. The computer-implemented method of claim 1, wherein the service image further comprises collective runtime state data corresponding to the first plurality of service resources of the first service, the collective runtime state data comprising 1) content of one of the first plurality of service resources, 2) one or more current network configurations associated with the first service, 3) one or more network security policies of the first service, and 4) data corresponding to one or more running processes of the first plurality of service resources.

24. The computer-implemented method of claim 23, wherein the one or more current network configurations provides information associated with at least one of a virtual network, a subnet, a routing table, or a security group.

25. The computer-implemented method of claim 1, wherein the first plurality of service resources comprises at least one control plane component of the first service and at least one data plane component of the first service.
